(19) United States
(12) Patent Application Publication
(10) Pub. No.: US 2017/0083603 A1
(43) Pub. Date: Mar. 23, 2017

(54) CO-DERIVED DATA STORAGE PATTERNS FOR DISTRIBUTED STORAGE SYSTEMS

(71) Applicant: QUALCOMM Incorporated, San Diego, CA (US)

(72) Inventors: Lorenz Christoph Minder, Evanston, IL (US); Michael George Luby, Berkeley, CA (US)

(21) Appl. No.: 14/954,877

(22) Filed: Nov. 30, 2015

Related U.S. Application Data
(60) Provisional application No. 62/220,787, filed on Sep. 18, 2015.

(51) Int. Cl. G06F 17/30

(52) U.S. Cl. CPC G06F 17/30598

(57) ABSTRACT

Embodiments providing co-derived data storage patterns for use in reliably storing data and/or facilitating access to data within a storage system using fragments of source objects are disclosed. A set of data storage patterns for use in storing the fragments distributed across a plurality of storage nodes may be generated whereby the set of data storage patterns are considered collectively to meet one or more system performance goals. Such co-derived data storage pattern sets may be utilized when storing fragments of a source object to storage nodes of a storage system. Co-derived pattern set management logic may generate co-derived data storage pattern sets, select/assign data storage patterns of a co-derived data storage pattern set for use with respect to source objects, modify data storage patterns of a co-derived data storage pattern set, and generate additional data storage patterns for a co-derived data storage pattern set in accordance with the concepts herein.

### CROSS-REFERENCE TO RELATED APPLICATIONS

This application claims the benefit of U.S. Provisional Patent Application No. 62/220,787 entitled, “CO-DERIVED DATA STORAGE PATTERNS FOR DISTRIBUTED STORAGE SYSTEMS”, filed on Sep. 18, 2015, which is expressly incorporated by reference herein in its entirety

### DESCRIPTION OF THE RELATED ART

The creation, management, storage, and retrieval of electronic data has become nearly ubiquitous in the day-to-day world. Such electronic data may comprise various forms of information, such as raw data (e.g., data collected from sensors, monitoring devices, control systems, etc.), processed data (e.g., metrics or other results generated from raw data, data aggregations, filtered data, etc.), produced content (e.g., program code, documents, photographs, video, audio, etc.), and/or the like. Such data may be generated by various automated systems (e.g., network monitors, vehicle on-board computer systems, automated control systems, etc.), by user devices (e.g., smart phones, personal digital assistants, personal computers, digital cameras, tablet devices, etc.), and/or a number of other devices.

Regardless of the particular source or type of data, large quantities of electronic data are generated, stored, and accessed every day. Accordingly sophisticated storage systems, such as network attached storage (NAS), storage area networks (SANs), and cloud based storage (e.g., Internet area network (IAN) storage systems), have been developed to provide storage of large amounts of electronic data. Such storage systems provide a configuration in which a plurality of storage nodes are used to store the electronic data of one or more users/devices, and which may be stored and retrieved via one or more access servers.

FIG. 1A shows an exemplary implementation of storage system 100A in which access server 110 is in communication with end user (EU) device 120 to provide storage services with respect thereto. Access server 110 may comprise one or more servers operable under control of an instruction set to receive data from devices such as EU device 120, and to control storage of the data and to retrieve data in response to requests from devices such as EU device 120. Accordingly, access server 110 is further in communication with a plurality, M, of storage nodes (shown here as storage nodes 130-1 through 130-M). Storage nodes 130-1 through 130-M may comprise a homogeneous or heterogeneous collection or array (e.g., redundant array of independent disks (RAID) array) of storage media (e.g., hard disk drives, optical disk drives, solid state drives, random access memory (RAM), flash memory, etc.) providing persistent memory in which the electronic data is stored by and accessible through access server 110. Each such storage node may be, for example, a commodity web server. Alternatively, in some deployments at least some storage nodes may be personal devices interconnected over the Internet. EU device 120 may comprise any configuration of device which operates to generate, manage, and/or access electronic data. It should be appreciated that although only a single such device is shown, storage system 100A may operate to serve a plurality of devices, some or all of which may comprise devices in addition to or in the alternative to devices characterized as “end user” devices.

FIG. 1B shows an exemplary implementation of storage system 100B in which access servers 110-1 through 110-14 may communicate with one or more EU devices of EU devices 120-1 through 120-3 to provide storage services with respect thereto. It should be appreciated that storage system 100B shows an alternative configuration to that of 100A discussed above wherein, although the access servers, EU devices, and storage nodes may be embodied as described above, the storage nodes of storage system 110B are deployed in a cluster configuration, shown as storage node cluster 130. In operation of storage system 100B, a cluster of access servers have access to the cluster of storage nodes. Thus, the EU devices may connect in a variety of ways to various access servers to obtain data services. In some cases, the access servers may be distributed around the country such that no matter where the EU device is located it may access the data stored in the storage node cluster. Storage nodes of such a configuration may be distributed geographically as well.

Source blocks of electronic data are typically stored in storage systems such as storage systems 100A and 100B as objects. Such source blocks, and thus the corresponding objects stored by the storage systems, may comprise individual files, collections of files, data volumes, data aggregations, etc. and may be quite large (e.g., on the order of megabytes, gigabytes, terabytes, etc.). The objects are often partitioned into smaller blocks, referred to as fragments (e.g., a fragment typically consisting of a single symbol), for storage in the storage system. For example, an object may be partitioned into k equal-sized fragments (i.e., the fragments comprise blocks of contiguous bytes from the source data) for storage in storage systems 100A and 100B. Each of the k fragments may, for example, be stored on a different one of the storage nodes.

In operation, storage systems such as storage systems 100A and 100B are to provide storage of and access to electronic data in a reliable and efficient manner. For example, in a data write operation, access server 110 may operate to accept data from EU device 120, create objects from the data, create fragments from the objects, and write the fragments to some subset of the storage nodes. Correspondingly, in a data read operation, access server 110 may receive a request from EU device 120 for a portion of stored data, read appropriate portions of fragments stored on the subset of storage nodes, recreate the object or appropriate portion thereof, extract the requested portion of data, and provide that extracted data to EU device 120. However, the individual storage nodes are somewhat unreliable in that they can intermittently fail, in which case the data stored on them is temporarily unavailable, or permanently fail, in which case the data stored on them is permanently lost (e.g., as represented by the failure of storage node 130-2 in FIG. 1C).

Erasure codes (e.g., tornado codes, low-density parity-check codes, Reed-Solomon coding, and maximum distance separable (MDS) codes) have been used to protect source data against loss when storage nodes fail. When using an erasure code, such as MDS erasure codes, erasure encoding is applied to each source fragment (i.e., the k fragments into which an object is partitioned) of an object to generate repair data for that fragment, wherein the resulting repair fragments are of equal size with the source fragments. In operation of the storage system, the source fragments and corresponding repair fragments are each stored on a different one of the storage nodes.

The erasure code may provide r repair fragments for each source object, whereby the total number of fragments, n, for a source object may be expressed as n=k+r. Thus, the erasure code may be parameterized as (n; k; r) where k is the number of source symbols in a source block, n is the total number of encoded symbols, and r=n−k is the number of repair symbols. A property of MDS erasure codes is that all k source symbols can be recovered from any k of the n encoded symbols (i.e., the electronic data of the source block may be retrieved by retrieving any combination (source and/or repair fragments) of k fragments. Although providing data reliability, it should be appreciated that where desired data is not directly available (e.g., a fragment is unavailable due to a failed storage node), to recreate the missing data k fragments must be accessed to recreate the missing data (i.e., k times the amount of data must be accessed to recreate the desired but missing data). This can result in inefficiencies with respect to the use of resources, such as communication bandwidth, computing resources, etc.

The storage system may store a source object on the set of M storage nodes thereof by encoding the source objects into n (e.g., n<M) equal sized fragments, and storing each of the n fragments on a distinct storage node. For example, when a source object is placed on the storage system, the source object may be split into k equal sized fragments, and compute r (e.g., r=n−k) repair fragments of the same size as the source fragments using an erasure code. The resulting n (i.e., n=k+r) fragments may then be stored to n storage nodes of the M storage nodes in the storage system.

The particular storage nodes upon which the n fragments for any source object are stored is typically selected by assigning the source object to a data storage pattern (also referred to as a placement group), wherein each data storage pattern is a set of n preselected storage nodes. That is, a data storage pattern is a set of n storage nodes on which the fragments of a source object are placed. In a typical storage system, the number of patterns t is approximately a constant multiple of the number of storage nodes M. The number of data storage patterns can vary over time, such as due to storage node failures rendering data storage patterns incident thereon obsolete. In alternative embodiments, a data storage pattern is a set of n preselected disks, wherein a disk may be a HDD disk or an SSD or any other type of storage device and wherein a storage node may host multiple disks. That is, a data storage pattern is a set of n disks on which fragments of a source object are placed.

The data storage patterns in conventional systems are typically selected pseudo-randomly. For example, data storage patterns may not be selected uniformly at random, but instead selected so as to increase the reliability of each individual data storage pattern. In particular, the individual data storage patterns may each be designed so as to minimize the risk that several storage nodes in the data storage pattern fail simultaneously. For example, a data storage pattern may be selected to avoid using storage nodes from the same physical equipment rack within that data storage pattern. Thus, data storage patterns are often selected in a pseudorandom manner to reduce the risk of correlated failures within the individual data storage patterns themselves, such as by avoiding nearby storage nodes in the same data storage pattern.

Regardless of how the t data storage patterns are chosen, when a random storage node fails, there are an average of a₁:=t·n/M data storage patterns affected by this failure. Where data storage patterns are chosen independently at random, the number of affected data storage patterns is approximately a Poisson variate with mean a₁. Thus, for some storage node failures, the number of data storage patterns affected is significantly larger than for others. If a storage node with many incident data storage patterns fails, the affected data will be at risk for a longer amount of time and the repair system will be loaded for a longer time.

Moreover, unequal loading of the storage nodes with fragments (e.g., as a result of the particular data storage patterns chosen) leads to unbalanced access and the need for excessive spare capacity on the storage nodes. One conventional way to address this problem has been to choose a relatively large number of data storage patterns (i.e., pick a relatively large t value), resulting in the loading of the nodes being more concentrated around the mean. However, such a use of a larger t value can decrease the overall storage system reliability because the number of critical sets of storage nodes whose failures result in data loss is correspondingly increased (e.g., the more data storage patterns utilized, the more data storage node failure patterns that can potentially result in loss of data).

### SUMMARY

A method for providing a set of data storage patterns for storing a plurality of source objects as a plurality of fragments on a plurality of storage nodes of a distributed storage system is provided according to embodiments herein. The method of embodiments includes constructing, by processor-based logic, a co-derived data storage pattern set having a plurality of data storage patterns, wherein each data storage pattern of the plurality of data storage patterns designate a subset of storage nodes on which fragments of a source object are to be stored, and wherein the plurality of data storage patterns are derived using at least one collective set-based construction methodology. Embodiments of the method further include providing the co-derived data storage pattern set for assignment of one of the data storage patterns of the plurality of data storage patterns to each source object of the plurality of source objects.

An apparatus for providing a set of data storage patterns for storing a plurality of source objects as a plurality of fragments on a plurality of storage nodes of a distributed storage system is provided according to further embodiments herein. The apparatus of embodiments includes one or more data processors and one or more non-transitory computer-readable storage media containing program code configured to cause the one or more data processors to perform particular operations. The operations performed according to embodiments include constructing a co-derived data storage pattern set having a plurality of data storage patterns, wherein each data storage pattern of the plurality of data storage patterns designate a subset of storage nodes on which fragments of a source object are to be stored, and wherein the plurality of data storage patterns are derived using at least one collective set-based construction methodology. The operations performed according to embodiments further include providing the co-derived data storage pattern set for assignment of data storage patterns of the data storage patterns to each source object of the plurality of source objects.

An apparatus for providing a set of data storage patterns for storing a plurality of source objects as a plurality of fragments on a plurality of storage nodes of a distributed storage system is provided according to still further embodiments herein. The apparatus of embodiments includes means for constructing a co-derived data storage pattern set having a plurality of data storage patterns, wherein each data storage pattern of the plurality of data storage patterns designate a subset of storage nodes on which fragments of a source object are to be stored, and wherein the plurality of data storage patterns are derived using at least one collective set-based construction methodology. The apparatus of embodiments further includes means for providing the co-derived data storage pattern set for assignment of data storage patterns of the data storage patterns to each source object of the plurality of source objects.

A non-transitory computer-readable medium comprising codes for providing a set of data storage patterns for storing a plurality of source objects as a plurality of fragments on a plurality of storage nodes of a distributed storage system is provided according to yet further embodiments herein. The codes of embodiments cause a computer to construct a co-derived data storage pattern set having a plurality of data storage patterns, wherein each data storage pattern of the plurality of data storage patterns designate a subset of storage nodes on which fragments of a source object are to be stored, and wherein the plurality of data storage patterns are derived using at least one collective set-based construction methodology. The codes of embodiments further cause a computer to provide the co-derived data storage pattern set for assignment of data storage patterns of the data storage patterns to each source object of the plurality of source objects.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIGS. 1A and 1B show exemplary implementations of storage systems as may be adapted to provide co-derived data storage pattern sets according to embodiments of the present disclosure.

FIG. 1C shows failure of a storage node as may be experienced in the storage systems of FIGS. 1A and 1B.

FIGS. 2A and 2B show detail with respect to exemplary implementations of storage systems adapted to provide co-derived data storage pattern sets according to embodiments of the present disclosure.

FIG. 3 shows a high level flow diagram of operation to provide co-derived data storage pattern sets for use in storing data to a distributed storage system according to embodiments of the present disclosure.

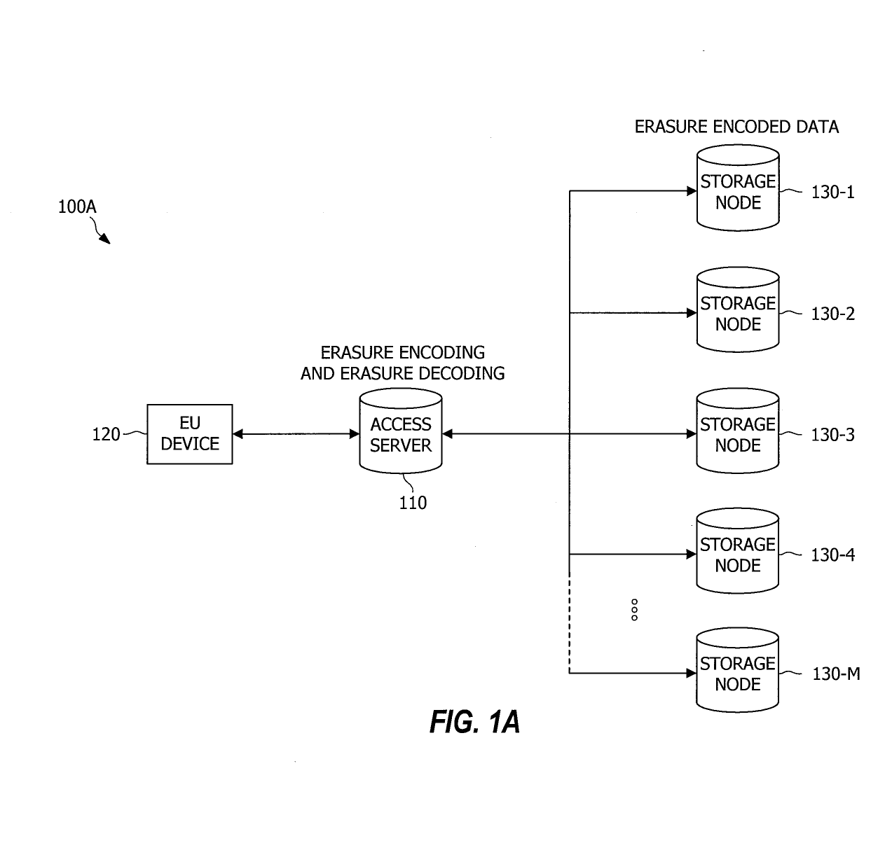

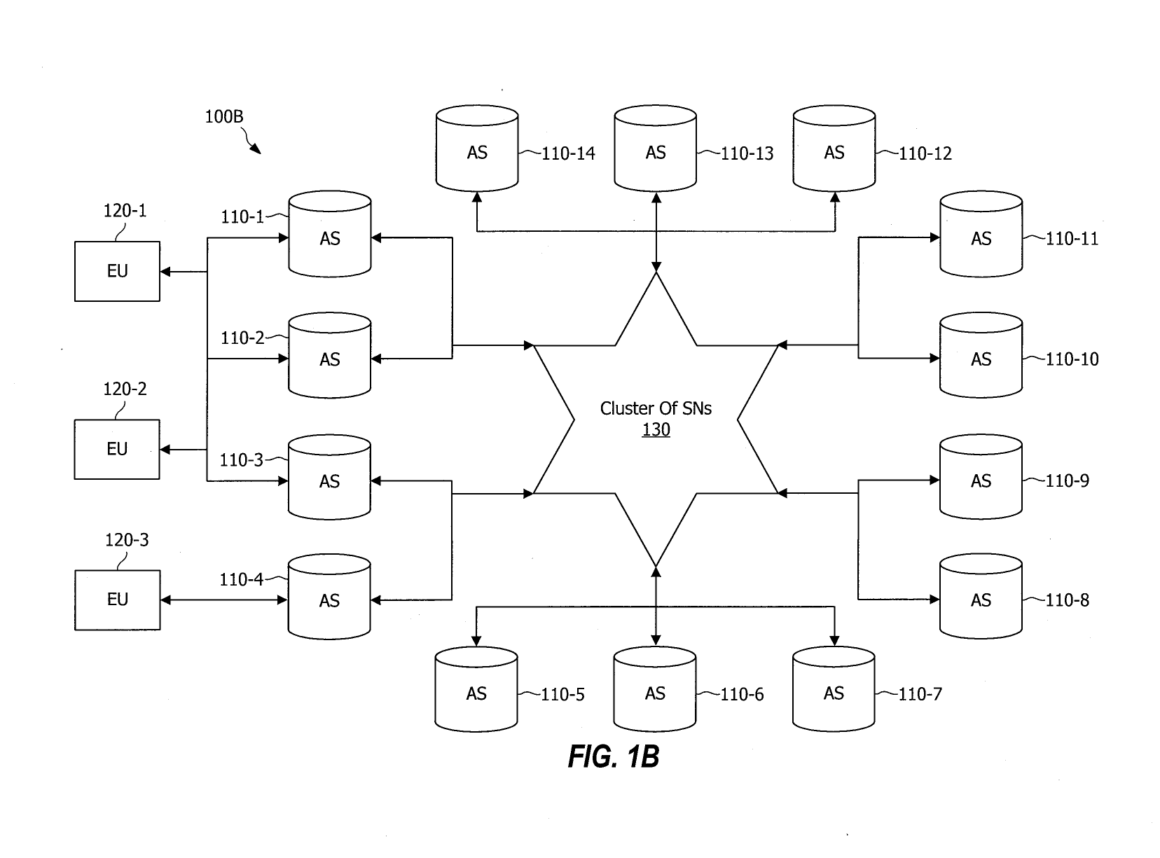

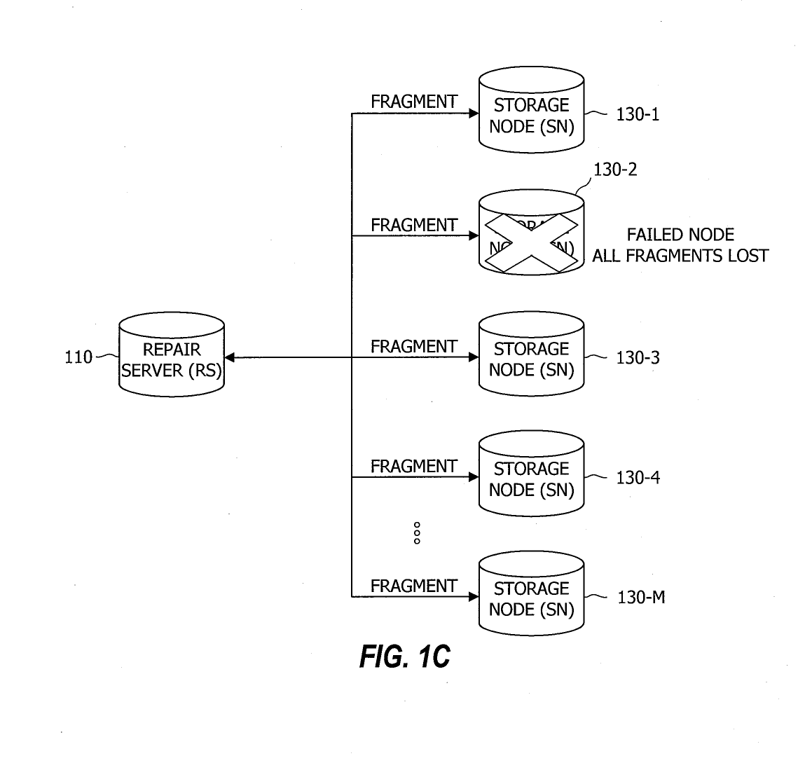

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “data” and “electronic data” may include information and content of various forms, including raw data, processed data, produced content, and/or the like, whether being executable or non-executable in nature. Such data may, for example, include data collected from sensors, monitoring devices, control systems, metrics or other results generated from raw data, data aggregations, filtered data, program code, documents, photographs, video, audio, etc. as may be generated by various automated systems, by user devices, and/or other devices.

As used in this description, the term “fragment” refers to one or more portions of content that may be stored at a storage node. For example, the data of a source object may be partitioned into a plurality of source fragments, wherein such source objects may comprise an arbitrary portion of source data, such as a block of data or any other unit of data including but not limited to individual files, collections of files, data volumes, data aggregations, etc.. The plurality of source fragments may be erasure encoded to generate one or more corresponding repair fragments, whereby the repair fragment comprises redundant data with respect to the source fragments. The unit of data that is erasure encoded/decoded is a source block, wherein k is the number of source symbols per source block, Bsize is the source block size, Ssize is the symbol size (Bsize=k·Ssize), n is the number of encoded symbols generated and stored per source block, and r is the number of repair symbols (r=n−k), and wherein the symbol is the atomic unit of data for erasure encoding/decoding. Although the symbol size (Ssize) may be different for different source blocks, the symbol size generally remains the same for all symbols within a source block. Similarly, although the number of source symbols (k), the number of repair symbols (r), and the number of encoded symbols generated may be different for different source blocks, the values generally remain the same for all source blocks of a particular object. Osize is the size of the source object and Fsize is the size of the fragment (e.g., where k is both the number of source symbols per source block and the number of fragments per source object, Osize=k·Fsize).

As used in this description, the terms “component,” “database,” “module,” “system,” “logic” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “user equipment,” “user device,” “end user device,” and “client device” include devices capable of requesting and receiving content from a web server or other type of server and transmitting information to a web server or other type of server. In some cases, the “user equipment,” “user device,” “end user device,” or “client device” may be equipped with logic that allows it to read portions or all of fragments from the storage nodes to recover portions or all of source objects. Such devices can be a stationary devices or mobile devices. The terms “user equipment,” “user device,” “end user device,” and “client device” can be used interchangeably.

As used herein, the term “user” refers to an individual receiving content on a user device or on a client device and transmitting information or receiving information from to a website or other storage infrastructure.

Embodiments according to the concepts of the present disclosure provide solutions with respect to storing and accessing source data in a reliable and efficient manner within a storage system of unreliable nodes (i.e., nodes that can store data but that can intermittently fail, in which case the data stored on them is temporarily unavailable, or permanently fail, in which case the data stored on them is permanently lost). In particular, embodiments herein provide methodologies, as may be implemented in various configurations of systems and methods, for reliably storing data and/or facilitating access to data within a storage system using fragment encoding techniques other than Maximum Distance Separable (MDS) codes, such as may utilize large erasure codes (e.g., RAPTOR Forward Error Correction (FEC) code as specified in IETF RFC 5053, and RAPTORQ Forward Error Correction (FEC) code as specified in IETF RFC 6330, of which software implementations are available from Qualcomm Incorporated). Although, large erasure codes have generally not been considered with respect to solutions for reliably and efficiently storing and accessing source data within a storage system of unreliable nodes due to potential demands on repair bandwidth and potential inefficient access when the desired data is not directly available, embodiments described in U.S. patent application Ser. Nos. 14/567,203, 14/567,249, and 14/567,303, each entitled “SYSTEMS AND METHODS FOR RELIABLY STORING DATA USING LIQUID DISTRIBUTED STORAGE,” each filed Dec. 11, 2014, the disclosures of which are hereby incorporated herein by reference, utilize a lazy repair policy (e.g., rather than a reactive, rapid repair policy as typically implemented by systems implementing a short erasure code technique) to control the bandwidth utilized for data repair processing within the storage system. The large erasure code storage control of embodiments operates to compress repair bandwidth (i.e., the bandwidth utilized within a storage system for data repair processing) to the point of operating in a liquid regime (i.e., a queue of items needing repair builds up and the items are repaired as a flow), thereby providing large erasure code storage control in accordance with concepts herein.

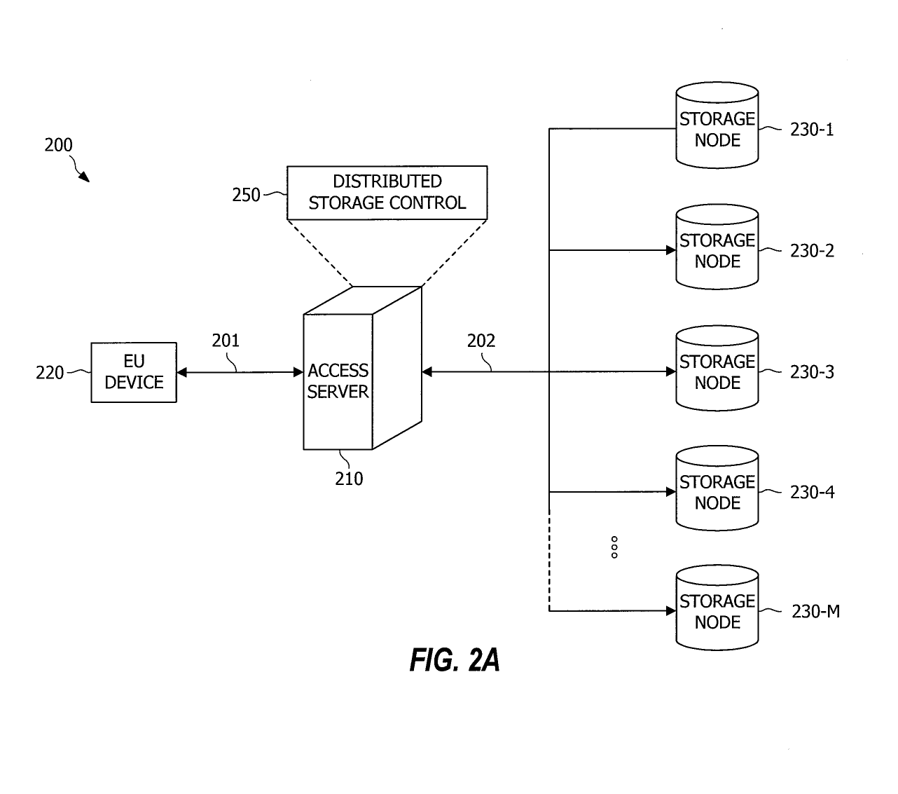

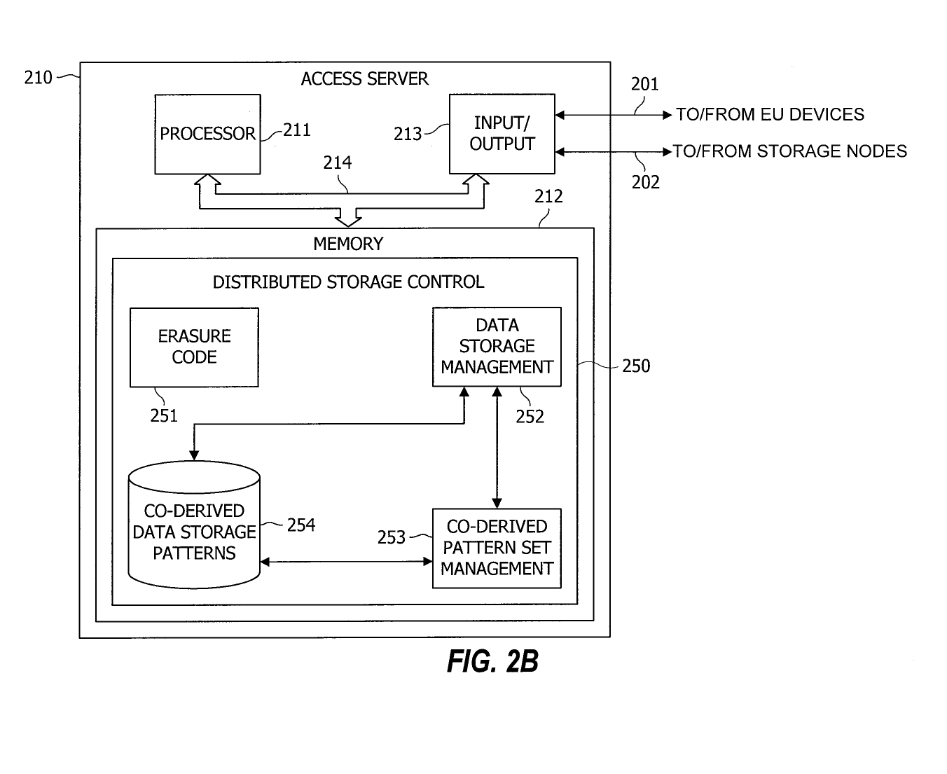

FIGS. 2A and 2B show storage system 200 adapted for co-derived data storage patterns according to the concepts herein. In operation of storage system 200 of embodiments, a set of data storage patterns for use in storing fragments of source objects distributed across a plurality of storage nodes are generated whereby the set of data storage patterns are considered collectively to meet one or more system performance goals, such as to increase the overall performance resulting from the combined use of the data storage patterns. Such data storage patterns are referred to herein as a co-derived data storage pattern set due to their being constructed or otherwise derived through one or more collective set-based construction methodologies to provide data storage patterns which are mutually cooperative to meet overall storage system performance goals. To ensure an equal amount of data is stored on each node, each pattern may be assigned an equal amount of object data and all nodes may have the same number of patterns that map fragments to them according to embodiments. To avoid correlated node failures causing loss of multiple fragments from a pattern, each pattern of embodiments may map fragments to nodes that fail independently. For example, a co-derived pattern provided according to embodiments may not map multiple fragments to nodes in the same rack, as node failures in the same rack can be highly correlated. To minimize the number of objects with already missing fragments that lose additional fragments when additional nodes fail, as few patterns as possible (e.g., no two patterns) map fragments to the same pair of nodes, and more generally patterns map fragments to as few nodes in common as possible, in accordance with some embodiments herein. Accordingly, in contrast to typical operation to select data storage patterns independently, a complete set of data storage patterns is crafted in a way to increase the overall system performance and reliability.

System performance goals for which co-derived data storage pattern sets are designed to meet may include balanced operation (e.g., storage node load balancing, balancing of source object data assigned to storage node patterns, etc.), system reliability (e.g., data reliability, etc.), and/or resource utilization efficiency (e.g., reduced storage node spare capacity, repair bandwidth efficiency, etc.), and/or adaptability to the dynamic storage system environment (e.g., maintaining performance objectives as availability of storage nodes changes, accommodating storage system configuration changes, etc.), for example. Accordingly, in operation according to embodiments co-derived data storage pattern sets are constructed to be balanced, reducing both the risk of overloading individual storage nodes and the amount of spare capacity needed on the storage nodes. The balanced property of the co-derived data storage pattern sets of embodiments also improves load balancing in the storage system when data is accessed. Additionally or alternatively, in operation according to embodiments co-derived data storage pattern sets are constructed such that the overall system reliability is increased. A common problem with distributed storage systems is that the loss of a few storage nodes can put an appreciable amount of stress on the system if those failed storage nodes affect many repair patterns. In such a case, repairing the affected data may require a large amount of bandwidth in the storage system for an extended period of time to read the requisite remaining fragments, generate appropriate repair fragments, and store the generated fragments to appropriate storage nodes. Until the repair completes, data is at risk of being lost completely due to further failing storage nodes. The use of co-derived data storage pattern sets of embodiments herein significantly improves on this situation by eliminating the possibility that substantially more than the expected number of data storage patterns are affected by any particular storage node failure.

For example, consider the situation in which j storage nodes fail within a relatively short period of time (e.g., the storage system repair process does not affect repairs for the erased fragments throughout failure of the j storage nodes). In this situation, an average of

$${a}_{j} := t \cdot \frac{( \begin{matrix}n \\ j\end{matrix} )}{( \begin{matrix}M \\ j\end{matrix} )}$$

data storage patterns are affected to the full extent (i.e., are incident with all j failed storage nodes). If the data storage patterns are placed randomly, however, some storage node failure patterns will usually exhibit many more than aⱼ affected data storage patterns. Thus, embodiments operate to construct data storage patterns of a co-derived data storage pattern set so that j random storage node failures are unlikely to affect too many data storage patterns. For example, data storage patterns of co-derived data storage pattern sets of embodiments are purposefully designed so that each storage node is incident with a similar number of the data storage patterns. Such co-derived data storage pattern sets avoid the need for a very large number of data storage patterns (i.e., a very large t value). In the ideal case, each storage node is incident with exactly the same number, a₁, of data storage patterns, in which case the load on the storage nodes would be perfectly balanced.

Embodiments may utilize various methodologies in constructing co-derived data storage pattern sets that meet one or more of the foregoing system performance goals. For example, some embodiments herein may utilize randomized constructions to create data storage patterns that collectively show equal sharing of the data storage patterns per storage node, such as to facilitate load balancing. Additionally or alternatively some embodiments may utilize combinatorial designs to decorrelate the data storage patterns of the set, such as to minimize data storage pattern/storage node commonality in the set of data storage patterns. Similarly, some embodiments may additionally or alternatively utilize relaxed patterns when responding to storage node failures, such as to adapt to the dynamically changing storage node environment without the repair bandwidth blocking access to one or more storage nodes. Any or all such methodologies may be implemented by co-derived data storage pattern set management logic of embodiments to generate co-derived data storage pattern sets, select/assign data storage patterns of a co-derived data storage pattern set for use with respect to source objects, modify data storage patterns of a co-derived data storage pattern set, and/or generate additional data storage patterns for a co-derived data storage pattern set.

In facilitating the foregoing, the exemplary embodiment of FIG. 2A comprises access server 210, having distributed storage control logic 250 according to the concepts herein, in communication with EU device 220 to provide storage services with respect thereto. Source data for which storage services are provided by storage systems of embodiments herein may comprise various configurations of data including blocks of data (e.g., source blocks of any size) and/or streams of data (e.g., source streams of any size). The source objects corresponding to such source data as stored by storage systems of embodiments, may comprise individual files, collections of files, data volumes, data aggregations, etc., as well as portions thereof, as may be provided for storage processing (e.g., encoding, writing, reading, decoding, etc.) as blocks of data, streams of data, and combinations thereof. Thus, source objects herein may comprise application layer objects (e.g., with metadata), a plurality of application layer objects, some portion of an application layer object, etc. Such source objects may thus be quite small (e.g., on the order of hundreds or thousands of bytes), quite large (e.g., on the order of megabytes, gigabytes, terabytes, etc.), or any portion of data that may be separated into fragments or portions of fragments as described herein.

Access server 210 may comprise one or more servers operable under control of an instruction set to receive data from devices such as EU device 220, and to control storage of the data and to retrieve data in response to requests from devices such as EU device 220, wherein the HTTP 1.1 protocol using the GET and PUT and POST command and byte range requests is an example of how an EU device can communicate with an access server 210. Accordingly, access server 210 is further in communication with a plurality, M, of storage nodes (shown here as storage nodes 230-1 through 230-M), wherein the HTTP 1.1 protocol using the GET and PUT and POST command and byte range requests is an example of how an access server 210 can communicate with storage nodes 230-1 through 230-M. The number of storage nodes, M, is typically very large, such as on the order of hundreds, thousands, and even tens of thousands in some embodiments. Storage nodes 230-1 through 230-M may comprise a homogeneous or heterogeneous collection or array (e.g., RAID array) of storage media (e.g., hard disk drives, optical disk drives, solid state drives, RAM, flash memory, high end commercial servers, low cost commodity servers, personal computers, tablets, Internet appliances, web servers, SAN servers, NAS servers, IAN storage servers, etc.) providing persistent memory in which the electronic data is stored by and accessible through access server 210. EU device 220 may comprise any configuration of device (e.g., personal computer, tablet device, smart phone, personal digital assistant (PDA), camera, Internet appliance, etc.) which operates to generate, manage, and/or access electronic data. It should be appreciated that although only a single such device is shown, storage system 200 may operate to serve a plurality of devices, some or all of which may comprise devices in addition to or in the alternative to devices characterized as “end user” devices. Any or all of the foregoing various components of storage system 200 may comprise traditional (e.g., physical) and/or virtualized instances of such components, such as may include virtualized servers, virtualized networking, virtualized storage nodes, virtualized storage devices, virtualized devices, etc.

FIG. 2B shows additional detail with respect to access server 210 of embodiments. Access server 210 of the illustrated embodiment comprises a plurality of functional blocks, shown here as including processor 211, memory 212, and input/output (I/O) element 213. Although not shown in the representation in FIG. 2B for simplicity, access server 210 may comprise additional functional blocks, such as a user interface, a radio frequency (RF) module, a display, etc., some or all of which may be utilized by operation in accordance with the concepts herein. The foregoing functional blocks may be operatively connected over one or more buses, such as bus 214. Bus 214 may comprises the logical and physical connections to allow the connected elements, modules, and components to communicate and interoperate.

Processor 211 of embodiments can be any general purpose or special purpose processor capable of executing instructions to control the operation and functionality of access server 210 as described herein. Although shown as a single element, processor 211 may comprise multiple processors, or a distributed processing architecture.

I/O element 213 can include and/or be coupled to various input/output components. For example, I/O element 213 may include and/or be coupled to a display, a speaker, a microphone, a keypad, a pointing device, a touch-sensitive screen, user interface control elements, and any other devices or systems that allow a user to provide input commands and receive outputs from access server 210. Additionally or alternatively, I/O element 213 may include and/or be coupled to a disk controller, a network interface card (NIC), a radio frequency (RF) transceiver, and any other devices or systems that facilitate input and/or output functionality of client device 210. I/O element 213 of the illustrated embodiment provides interfaces (e.g., using one or more of the aforementioned disk controller, NIC, and/or RF transceiver) for connections 201 and 202 providing data communication with respect to EU device 220 and storage nodes 230-1 through 230-M, respectively. It should be appreciated that connections 201 and 202 may comprise various forms of connections suitable for data communication herein, such as provided by wireline links, wireless links, local area network (LAN) links, wide area network (WAN) links, SAN links, Internet links, cellular communication system links, cable transmission system links, fiber optic links, etc., including combinations thereof.

Memory 212 can be any type of volatile or non-volatile memory, and in an embodiment, can include flash memory. Memory 212 can be permanently installed in access server 210, or can be a removable memory element, such as a removable memory card. Although shown as a single element, memory 212 may comprise multiple discrete memories and/or memory types. Memory 212 of embodiments may store or otherwise include various computer readable code segments, such as may form applications, operating systems, files, electronic documents, content, etc.

Access server 210 is operable to provide reliable storage of data within storage system 200 using erasure coding and/or other redundant data techniques, whereby co-derived data storage pattern sets according to the concepts herein are provided for use with respect to the storage of the data. Accordingly, memory 212 of the illustrated embodiments comprises computer readable code segments defining distributed storage control logic 250, which when executed by a processor (e.g., processor 211) provide logic circuits operable as described herein. In particular, distributed storage control logic 250 of access server 210 is shown in FIG. 2B as including a plurality of functional blocks as may be utilized alone or in combination to provide and/or utilize co-derived data storage pattern sets in association with reliably storing data within storage system 200 according to embodiments herein. Further detail regarding the implementation and operation of liquid distributed storage control by a storage system is provided in U.S. patent application Ser. Nos. 14/567,203, 14/567,249, and 14/567,303 each entitled “SYSTEMS AND METHODS FOR RELIABLY STORING DATA USING LIQUID DISTRIBUTED STORAGE,” and each filed Dec. 11, 2014, the disclosures of which are hereby incorporated herein by reference.

Distributed storage control logic 250 of the illustrated embodiment includes erasure code logic 251, data storage management logic 252, and co-derived pattern set management logic 253. It should be appreciated that embodiments may include a subset of the functional blocks shown and/or functional blocks in addition to those shown. In some embodiments, an instance of co-derived pattern set management logic 253 may be separate from the distributed storage control logic 250, such as to provide construction of co-derived data storage pattern sets external to the operation of the distributed storage system (e.g., for initial provisioning, for offloading the co-derived data storage pattern set construction, etc.).

The code segments stored by memory 212 may provide applications in addition to the aforementioned distributed storage control logic 250. For example, memory 212 may store applications such as a storage server, useful in arbitrating management, storage, and retrieval of electronic data between EU device 210 and storage nodes 230-1 through 230-M according to embodiments herein. Such a storage server can be a web server, a NAS storage server, a SAN storage server, an IAN storage server, and/or the like.

In addition to the aforementioned code segments forming applications, operating systems, files, electronic documents, content, etc., memory 212 may include or otherwise provide various registers, buffers, caches, queues, and storage cells used by functional blocks of access server 210. For example, memory 212 may comprise one or more system maps that is maintained to keep track of which fragments are stored on which nodes for each source object. Additionally or alternatively, memory 212 may comprise various registers or databases storing operational parameters utilized according to embodiments, such as erasure code parameters, data storage patterns, etc. Co-derived data storage patterns database 254 of the illustrated embodiment is an example of one such database utilized according to embodiments herein. Likewise, memory 212 may comprise one or more repair queues, such as repair queue 254, providing a hierarchy of source object instances for repair processing.

In operation according to embodiments, the source blocks of electronic data are stored in storage system 200 as objects. The source objects utilized herein may, for example, be approximately equal-sized. Source blocks, and thus the corresponding objects stored by the storage system, may comprise individual files, collections of files, data volumes, data aggregations, etc. and may be quite large (e.g., on the order of megabytes, gigabytes, terabytes, etc.). Data storage management logic 252 of access server 210 may operate to partition arriving source data into source objects and to maintain mapping of the source data to the source objects (e.g., Map:App−Obj comprising an application or source object map providing mapping of source data to objects). Data storage management logic 252 may further operate to erasure encode the source objects, divide the source objects into fragments, store each fragment of a source object at a different storage node, and maintain a source object to fragment map (e.g., Map:Obj−Frag comprising an object fragment map providing mapping of objects to fragments). Accordingly, the objects are partitioned by data storage management logic 252 of embodiments into fragments for storage in the storage system. For example, an object may be partitioned into k fragments for storage in storage system 200. Each of the k fragments may be of equal size according to embodiments. In operation according to embodiments herein the aforementioned fragments may comprise a plurality of symbols.

In providing resilient and reliable storage of the data, access server 210 of embodiments utilizes one or more erasure codes (e.g., erasure code logic 251 may implement one or more erasure codes, such as may comprise small erasure codes, large erasure codes, MDS codes, codes other than MDS codes, FEC codes, etc.) with respect to the source objects, wherein repair fragments are generated to provide redundant data useful in recovering data of the source object. For example, embodiments of data storage management logic 252 may control erasure code logic 251 to implement erasure codes parameterized as (n; k; r), where k is the number of source symbols in a source block, n is the total number of encoded symbols, and r is the number of repair symbols, wherein r=n−k. For example, when a source object is placed on the storage system, the source object may be split into k equal sized source fragments and r repair fragments of the same size computed by erasure code logic 251. It should be appreciated that, although embodiments of a co-derived data storage pattern set methodology herein are well suited for use with respect to small erasure codes, the concepts presented are readily applicable with respect to other data encoding techniques. For example, co-derived data storage pattern sets of embodiments may be utilized with respect to large erasure codes (e.g., RAPTOR Forward Error Correction (FEC) code as specified in IETF RFC 5053, and RAPTORQ Forward Error Correction (FEC) code as specified in IETF RFC 6330, of which software implementations are available from Qualcomm Incorporated), particularly where the number of storage nodes (M) is larger than the erasure code used (n).

An (n; k; r) erasure code solution, wherein (n; k; r) are small constants, is said to be a small erasure code solution if n<<M or if n is small independently of M (e.g. n<30, or n<20). In utilizing such a small erasure code, a source object is typically partitioned into k source fragments that are erasure encoded to generate n encoded fragments, wherein r of the n fragments are repair fragments. Of the M storage nodes in the storage system, n storage nodes may then be chosen (e.g., storage nodes chosen randomly, storage nodes having independent failures chosen, etc.) and the n fragments stored to the n chose storage nodes, one fragment per storage node. Maximum Distance Separable (MDS) erasure codes are an example of such small erasure codes. The repair strategy traditionally implemented with respect to such small erasure codes is a reactive, rapid repair policy.

An (n; k; r) erasure code solution is a large erasure code solution if n=M (i.e., for each source object there are fragments stored at all the storage nodes), if n is a significant fraction of M (e.g., n≧½·M), or if n is large although perhaps chosen independently of M (e.g., n≧50, or n≧30). An exemplary large erasure code such as may be utilized according to embodiments herein include RAPTORQ as specified in IETF RFC 6330, available from Qualcomm Incorporated. Further examples of large erasure codes as may be utilized herein include RAPTOR as specified in IETF RFC 5053, LDPC codes specified in IETF RFC 5170, tornado codes, and Luby transform (LT) codes.

A property of maximum distance separable (MDS) erasure codes is that all k source symbols can be recovered from any k of the n encoded symbols. Particular erasure codes that are not inherently MDS, such as the exemplary large erasure codes herein (e.g., RAPTORQ), provide a high (e.g., 99%) probability that the k source symbols can be recovered from any k of the n encoded symbols and a higher (e.g., 99.99%, 99.9999%, etc.) probability that the k source symbols can be recovered from any k+x (e.g., x=1, 2, etc.) of the n encoded symbols.

In operation, each fragment (i.e., the source fragments and repair fragments) of a source object is stored at a different storage node than the other fragments of the source object (although multiple fragments are stored at the same storage node in some embodiments). The storage overhead is the ratio of the total target amount of repair data for all objects divided by the total target amount of source and repair data for all objects in the storage system when using a systematic erasure code for storage. Thus, the storage overhead is the target fraction of the used storage that is not for source data.

In some cases, source data is not directly stored in the storage system, only repair data. In this case, there are n repair fragments stored in the storage system for each object, where generally any k (for some erasure codes slightly more than k is sometimes utilized) of the n fragments can be used to recover the original object, and thus there is still a redundant storage of r=n−k repair fragments in the storage system beyond the k needed to recover the object. An alternative type of storage overhead is the ratio of the total target amount of redundant data (r=n−k) divided by the total amount of source data (k), i.e., the storage overhead is r/k for this type. Generally herein r/n is used as the storage overhead, and one skilled in the art can see that there is a conversion from one type of storage overhead to the other type of storage overhead.

It should be appreciated that although the illustrated embodiment is shown as utilizing data encoding techniques (e.g., using erasure code logic 251) providing data redundancy, the concepts herein may be applied to embodiments providing data redundancy by means other than the aforementioned data encoding techniques. For example, embodiments of co-derived data storage pattern sets herein may be utilized with respect to data replication techniques providing data redundancy, such as where source object duplication or triplication is used instead of FEC encoding (e.g., where k=1 and n=2 for data duplication, k=1 and n=3 for data triplication, etc.).

Irrespective of the particular data redundancy technique employed, or whether a combination of source fragments and repair fragments or only repair fragments are stored, the n fragments may be distributively stored on a plurality of the storage nodes. For example, the n fragments may then be stored to n storage nodes of the M storage nodes of storage system 200, whereby each of the n fragments are stored on a distinct storage node.

In implementing such partitioned storage of source data according to embodiments there can be a unique encoded symbol ID (ESI) associated with each of the M storage nodes, and all, fragments stored on the storage node may be generated using the ESI associated with that storage node. Thus a mapping may be maintained for each storage node indicating the associated ESI and a mapping may be maintained for each source object indicating which fragments are stored on which storage nodes (e.g., a Map:Obj−Frag map indicating the encoded symbol ID (ESI) and the storage node ID for each fragment of each source object). Alternatively, mapping of ESIs to storage nodes may be maintained individually for each source object, or for a group of source objects, and thus a storage node may have a fragment associated with a first ESI for a first source object and a fragment associated with a second ESI for a second source object. In some embodiments, multiple ESIs may be mapped to the same storage node for a source object.

The particular storage nodes upon which the n fragments for any source object are stored may be selected by assigning the source object to a data storage pattern (also referred to as a placement group), wherein each data storage pattern is a set of n preselected storage nodes (e.g., as may be identified by a storage node identifier). That is, a data storage pattern is a set of n storage nodes on which the fragments of a source object are placed. In a typical storage system where n is much smaller than M, the number of patterns t may be approximately a constant multiple of the number of storage nodes M. The number of data storage patterns can vary over time, such as due to storage node failures rendering data storage patterns incident thereon obsolete.

Embodiments herein may for different sets of objects operate to assign ESIs in a different order (e.g., permutation of the ESIs) to the same set of storage nodes of a large/liquid storage system. Furthermore, different sets of ESIs may be assigned to the same set of storage nodes for different sets of objects. In implementing such an ESI pattern for a set of objects (i.e., an ESI pattern is a mapping of a set of ESIs to a set of storage nodes for a given set of objects) technique according to embodiments, a set of ESI patterns is specified to the same set of storage nodes (e.g., the available storage nodes), wherein the ESIs assigned to the same storage node is different across the different ESI patterns. As an example, 100 ESI patterns may be specified that map a given set of 3000 ESIs to the same set of 3000 storage nodes (e.g., where k=2000 and n=3000), wherein the mapping of the ESIs to the storage nodes for each ESI pattern may be specified by choosing each of the ESI patterns in a coordinated way. In accordance with embodiments, ESI patterns may be specified in a coordinated way so that there is anti-correlation, or at least not correlation, in the probability of failing the verification of code resiliency test for the ESI patterns when a storage node fails. For example, for RAPTORQ, each ESI I corresponds to a symbol that is formed as the XOR of a certain number w(I) of symbols from the intermediate block (wherein the intermediate block is generated from the source block), where w(I) depends on I and varies between 2 and approximately 30 for different values of I, and w(I) is called the weight of I. Thus, one coordinated way of determining a set of ESI patterns is to ensure that the sum of w(I) over all ESI I assigned to a storage node (summed over all ESI patterns) is approximately the same for each storage node. This can be beneficial, as it may be the case that symbols associated with ESIs may be more likely to help to decode than other ESIs based on the weight of the ESI (i.e., ESIs with higher weight can be more likely to help to decode). Thus, when a storage node is lost, the sum over the ESI patterns of the weights of the ESIs of symbols stored on that storage node is equal, and if one ESI pattern fails the verification of code resiliency test it makes it less likely that other ESI patterns fail the test.

As another example of choosing ESI patterns in a coordinated way, the ESI patterns may be chosen randomly or pseudo-randomly, and then extensive testing could verify that there is no correlation in the probability of failing the verification code test for the ESI patterns. If correlation is found, then ESI patterns can be discarded and new ESI patterns added for further testing, until a suitable set of ESI patterns is determined. As an alternative, or in addition, the ESIs utilized within an ESI pattern may be discarded if they are found to cause (or be correlated with) failures of the verification code test for that ESI pattern, and discarded ESIs may be replaced with different ESIs to be utilized by the ESI pattern.

As another variant, ESI patterns may map to differing sets of storage nodes. As a special case, consider an equipment rack of storage nodes with multiple disks (e.g., hard drives and/or SSD drives) associated with each storage node. For example, in an implementation of the foregoing, a storage system might include 1000 equipment racks having 40 storage nodes per rack with 50 disks per storage node. The ESI patterns utilized with such a storage system may, for example, comprise a set of 2000 ESI patterns, wherein each pattern maps one of its 1000 ESIs to exactly one disk within each of the 1000 equipment racks, i.e., each ESI pattern maps to 1000 disks, wherein each disk is within a storage node in a different equipment rack, and exactly one ESI pattern maps to each disk. As another example, the ESI patterns may comprise a set of 40 ESI patterns, wherein each pattern maps one of its 1000 ESIs to exactly one storage node within each of the 1000 equipment racks, i.e., each ESI pattern maps to 1000 storage nodes, where each storage node is within a different equipment rack, and exactly one ESI pattern maps to each storage node. The repair process for at most one ESI pattern may be active at a time, for example, and thus most of the infrastructure within an equipment rack may be powered down, thus requiring substantially less peak power. For example, at most one disk within the equipment rack is active at any point in time for the set of 2000 ESI patterns mapping to disks, or at most one storage node within an equipment rack is active at any point in time for the set of 40 ESI patterns mapping to storage nodes. It will readily be appreciated that there are many variants of the foregoing techniques, including mapping ESI patterns to overlapping sets of storage nodes or disks, etc.

In a variant of a distributed ESI pattern embodiment, wherein a fragment is stored on each storage node for each source object, there is a different ESI pattern ESIpat(I) assigned to each storage node I and a subset of the source objects O(I) assigned to each storage node, wherein approximately an equal amount of source object data is assigned to each storage node. The sets ESIpat(I) may, for example, be determined in a coordinated way for different storage nodes I, as described above. Each storage node I may be responsible for operating the repair process for the source objects O(I) and storing generated repair fragments according to ESI pattern ESIpat(I). Each storage node I may also be responsible for executing the verification resiliency test for the ESI pattern ESIpat(I). If at any point in time the verification resiliency test fails at a storage node I, storage node I may redistribute repair responsibility for the source objects O(I) to the other storage nodes in the storage system (e.g., with an indication that the source objects O(I) are in need of emergency repair). The other storage nodes that receive the responsibility for repair of the source objects O(I) may thus schedule the repair of source objects O(I) received from storage node I (e.g., schedule repair as soon as possible, potentially using more than the usual amount of repair bandwidth during the emergency repair). Once the redistributed repair finishes, the responsibility for repair of source objects O(I) may be returned to storage node I. In accordance with an alternative embodiment for the foregoing, the repair responsibility for source objects of O(I) remains with the storage nodes to which they were redistributed, and the ESI pattern used for storage of the source object is changed to that of the storage node to which they are redistributed (e.g., during the redistributed repair, the ESI pattern for the source object may be changed to the ESI pattern of the storage node performing the repair).

Irrespective of the particular ESI assignment scheme utilized, the aforementioned mapping information may be updated for source objects indicating which fragments are available when a storage node permanently fails. Access server 210 may operate to determine which source object particular source data (e.g., source data requested by EU device 220) is contained within (e.g., using a Map:App−Obj map) and to read the data from the storage nodes storing the appropriate fragments by determining which of the fragments contain relevant source or repair data (e.g., using a Map:Obj−Frag map).

The particular storage nodes upon which the n fragments for any source object are stored is selected according to embodiments by data storage management logic 252 assigning the source object to a data storage pattern of a co-derived data storage pattern set. For example, each data storage pattern of a co-derived data storage pattern set may comprise a set of n preselected storage nodes, whereby the n fragments for a source object are stored to that set of n preselected storage nodes.

Accordingly, the illustrated embodiment of distributed storage control logic 250 includes co-derived pattern set management logic 253 operable to generate co-derived data storage pattern sets, select/assign data storage patterns of a co-derived data storage pattern set for use with respect to source objects, modify data storage patterns of a co-derived data storage pattern set, and/or generate additional data storage patterns for a co-derived data storage pattern set in accordance with the concepts herein. Such co-derived data storage pattern sets may be stored for use by functionality of distributed storage control logic 250 within co-derived data storage patterns database 254, for example. Thus, embodiments of data storage management 252 may operate to utilize the data storage patterns of one or more co-derived data storage pattern sets when storing fragments of a source object to storage nodes of storage system 200.

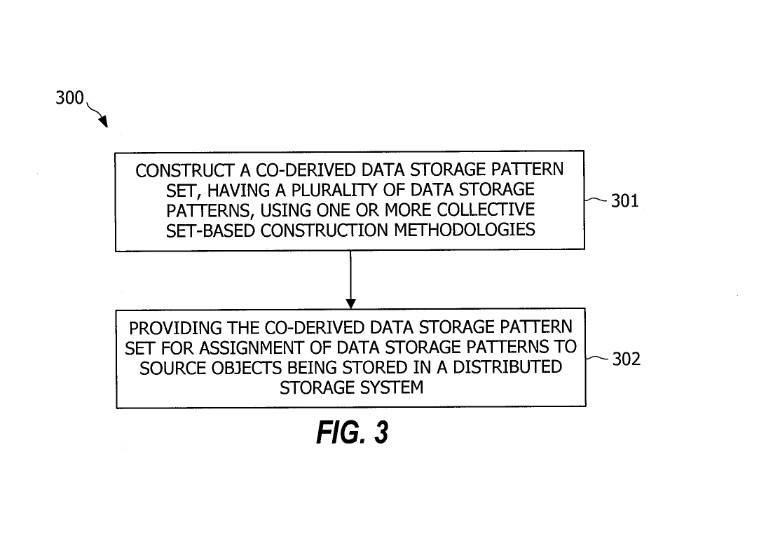

Flow 300 of FIG. 3 shows a high level flow diagram of operation to provide co-derived data storage pattern sets for use in storing data to a distributed storage system according to embodiments herein. At block 301 of the illustrated embodiment, co-derived pattern set management logic 253 operates to construct a co-derived data storage pattern set having a plurality of data storage patterns derived through one or more collective set-based construction methodologies, whereby the data storage patterns are mutually cooperative to meet overall storage system performance goals. Such co-derived data storage pattern sets may be generated using one or more collective set-based construction methodologies according to embodiments herein. For example, embodiments of co-derived pattern set management logic 253 utilize randomized constructions, combinatorial designs, relaxed patterns, and/or combinations thereof in generating, modifying, and/or regenerating data storage patterns of a co-derived data storage pattern set.

In operation according to embodiments, a system performance goal is to place a same amount of data onto each storage node. Embodiments may utilize randomized constructions to create data storage patterns that collectively show equal sharing of the data storage patterns per storage node in constructing a co-derived data storage pattern set at block 301. Thus, by assigning a same amount of data (e.g., a same number of equal size source objects) to the data storage patterns of a co-derived data storage pattern set, data uniformity may be provided with respect to the storage nodes of the storage system.

For a storage pattern P, let P(0), P(1), . . . , P(n−1) be the n storage nodes (amongst the M available storage nodes) to which fragments for objects assigned to the pattern are stored. A pattern P is said to be valid if all n values of P(0), P(1), . . . , P(n−1) are distinct, and a pattern P and a storage node i are said to be incident if for some j=0, . . . , n−1, P(j)=i. Operation of co-derived pattern set management logic 253 utilizing a randomized construction methodology constructs the data storage patterns of a co-derived data storage pattern set layer by layer, first creating a random permutation of the storage nodes and dividing the permutation into sections of equal size so that each of those sections gives one data storage pattern. In implementing an exemplary randomized construction methodology by co-derived pattern set management logic 253 of embodiments, assume n divides M. The exemplary randomized construction algorithm set forth below constructs t data storage patterns wherein each storage node is incident with at most [a₁] and at least [a₁] data storage patterns, where a₁ is the average number of patterns incident with a storage node.

```
for i = 0 to t − 1 do
      Let j := i modulo M/n
      if j = 0 then
          Let δ be a random permutation of {0, . . . ,M − 1}
      end if
      The i-th data storage pattern P is P(0) = δ_{j·n}, . . . , P(n −1) = δ_{(j+1)·n-1}
end for
```

It should be appreciated that if

$$t = c \cdot ( \frac{M}{n } ) ,$$

where c is a positive integer, then each storage node has exactly c incident patterns after execution of the above. Accordingly, this randomized construction provides for each storage node being equally loaded.

There are many variants of the above algorithm. For example, instead of choosing random permutations, pseudo-random permutations may be chosen, or permutations may be chosen using a deterministic process. Preferably, the permutations should be largely different from one another, such as to avoid producing pairs of patterns that are incident with a common pair of storage nodes. For example, as few permutations as possible have the same pair of values within groups of n values according to embodiments. However, as described in the subsequent additional embodiments, the determined t patterns may be further refined to determine improved pattern incidences with storage nodes.

Another randomized construction algorithm for balancing the load on the storage nodes is provided below. In the following, let b be a parameter (e.g., b=10).

```
L₀, . . . ,Lₜ₋₁ ← Set of t randomly chosen data storage patterns
for i = 0 to b · t · n do
    x ← Random integer in the range 0, . . . , t − 1
    y ← Random integer in the range 0, . . . , n − 1
    v ←Lₓ(y)
    s ← └(t · n)/M┘
    if (t · n modulo M) is less than v then
        s ← s + 1
    end if
    c ← the number of data storage patterns incident with node v
    if c > s then
        r ← Random storage node
        if the pattern Lₓ with Lₓ(y) reset to r is a valid pattern then
            Reset Lₓ(y) to r in Lₓ
        end if
    end if
end for
```

The foregoing illustrative randomized construction algorithm starts with patterns chosen randomly and gradually improves the storage balancing of the patterns so that the number of patterns incident with each storage node approaches the average number a₁. No particular assumption on the value of n or M is made, although the performance is better if n is much smaller than M. As the value of the parameter b increases the patterns in general are better balanced (i.e., the number of patterns incident with each storage node approaches the average number a₁). However, there is a trade-off between the balance achieved and the complexity of execution of the method, and in general perfect balance may not be achieved. As one skilled in the art will recognize, there are many variant embodiments. For example, random choices may instead be pseudo-random choices, or deterministic choices.

Implementation of the above exemplary randomized construction algorithms by co-derived pattern set management logic 253 of embodiments operates to improve the balancing of the individual storage nodes within co-derived data storage pattern sets. It should be appreciated, however, that when a particular storage node fails, that failure results in the erasure of fragments for each data storage pattern incident with the failed storage node. If any of those data storage patterns are also incident with another common storage node, the data that is stored using those data storage patterns is at risk because the loss of that common storage node affects the recoverability of the source objects assigned to each such data storage pattern. Accordingly, in an extension of the foregoing load balancing, embodiments implement techniques for ensuring that groups (e.g., pairs, triples, quadruples, etc.) of storage nodes have the same amount of data storage patterns assigned thereto, such as to minimize the number of source objects at risk of data loss for any particular storage node failure pattern.

The illustrative randomized construction algorithm below provides optimization of the load on tuples in a set of data storage patterns, L, without affecting the load on single storage nodes itself. Thus, it should be appreciated that the following randomized construction algorithm may be implemented in combination with (e.g., performed after) any of the foregoing randomized construction algorithms according to embodiments. In the following, let b be a parameter (e.g., b=5).

```
for b · M² iterations do
    Let x, y be a pair of distinct random storage nodes
    S ← The set of data storage patterns in L incident with both x and y
    if |S| > ┌a₂┐ then
        v ← random data storage pattern in S
        u ← random data storage pattern in L \ S
        j ← random entry in u having a value not present in v
        Swap the entry in v with value x with entry j in u
    end if
end for
```

As the value of the parameter b increases the patterns in general are better balanced (i.e., the number of patterns incident with pairs of nodes will approach the average number a₂). However, there is a trade-off between the balance achieved and the complexity of execution of the method, and in general perfect balance may not be achieved. As one skilled in the art will recognize, there are many variant embodiments. For example, random choices may instead be pseudo-random choices, or deterministic choices.

Additionally or alternatively, embodiments may utilize combinatorial designs to de-correlate the data storage patterns of co-derived data storage pattern sets when generating a co-derived data storage pattern set at block 301. For example, combinatorial designs, such as projective geometries designs, generalize the property wherein any pair of points has exactly one line that crosses them, such that the blocks and points of the combinatorial design may be constructed to de-correlate groupings of points. Accordingly, the storage nodes and data storage patterns of a co-derived data storage pattern set may be mapped to the points and blocks of a combinatorial design for de-correlation according to the concepts herein. Such use of combinatorial designs according to embodiments provides data storage patterns of a co-derived data storage pattern set with as little storage node commonality between the data storage patterns as practicable, and in many cases with uniform storage node commonality among all the data storage patterns of the set.

In deriving a combinatorial design methodology as may be utilized according to embodiments herein, let v̅, k̅, t̅, and λ̅ be integers. Let [symbol] (points) be a set where | [symbol] |=v̅ and let [symbol] (blocks) be a set of subsets of [symbol] , where |B|=k̅ for each Bε [symbol] . Then ( [symbol] , [symbol] ) is said to be a t̅−(v̅, k̅, λ̅)-design (or more simply, a t̅-design) if for any subset U⊂ [symbol] of size t, there are exactly λ̅ sets Bε [symbol] such that U⊂B. Such designs are extensively studied in combinatorics.

In implementing a combinatorial design methodology by co-derived pattern set management logic 253 of embodiments, consider P as a set of storage nodes, and P as a set of data storage patterns, wherein v̅=M and k̅=n. Accordingly, such a combinatorial design may thus be utilized by co-derived pattern set management logic 253 of embodiments to generate co-derived data storage pattern sets herein. Although designs only exist for select parameters t̅, v̅, k̅, λ̅, many choices of such select parameters are nevertheless suited for use in providing co-derived data storage pattern sets for a distributed storage system.

The number of blocks in a t̅−(v̅, k̅, λ̅)-design is

$$\overline{b} := \overline{λ} \cdot ( \begin{matrix}\overline{v} \\ \overline{t}\end{matrix} ) / ( \begin{matrix}\overline{k} \\ \overline{t}\end{matrix} ) .$$

An arbitrary set [symbol] of b̅ blocks of size k̅ each over a set of [symbol] of v̅ points (thus a set not necessarily satisfying the constraints of a design) has the property that a j-tuple chose at random among all the j-tuples of [symbol] has in expectation aⱼ(b̅, k̅, v̅):=b̅·(ⱼ^{k̅})/(ⱼ^{v̅}) blocks in [symbol] that are supersets of that j-tuple. (Note that a_{t̅}(b̅, k̅, v̅)=λ̅ if ( [symbol] , [symbol] ) is a t−(v̅, k̅, λ̅)-design.) A stronger property holds for designs: If ( [symbol] , [symbol] ) is in fact a t−(b̅, k̅, v̅)-design, then for 0≦j≦t̅, any j-tuple of points has deterministically aⱼ((b̅, k̅, v̅)) blocks in [symbol] as supersets.

Thus, where a t̅-design is used to provide data storage patterns of a co-derived data storage pattern set, each set of j≦t̅ storage nodes will be incident with exactly aⱼ((b̅, k̅, v̅)) data storage patterns. Such a t̅-design used to provide data storage patterns of a co-derived data storage pattern set provides thus the best balancing possible for sets of j storage nodes. Further, where a t̅-design is used to provide data storage patterns of a co-derived data storage pattern set with λ̅=1, any set of j>t̅ storage nodes will be incident with at most 1 data storage pattern providing the best balancing possible for sets of j storage nodes, since 0≦aⱼ((b̅, k̅, v̅))<1 in this case. Such t̅-designs with λ̅=1 are sometimes called Steiner systems in the literature of combinatorial designs.

For example, an embodiment of co-derived pattern set management logic 253 may utilize a combinatorial design, known in the theory of designs as a projective geometries, for generating a co-derived data storage pattern set. In implementing a projective geometries combinatorial design according to embodiments, let p be a prime number (a similar construction works if p is a prime power) and define a plurality of (0, 1)-matrices in accordance with the following:

L is a (p+1)×(p+1) matrix with the first row and first columns being 1s, and everything else being 0s (i.e., L_{i,j}=1 iff i=1 or j=1);
Cₘ is a p×(p+1) matrix with the m+2^{nd} column being a row of 1s, and everything else being 0s;
Rₘ is a (p+1)×p matrix with the m+2^{nd} row being a row of 1s and everything else being 0s;
Vₘ is a p×p matrix with the i, j-entry being equal to 1 iff i=j+m mod p. A v̅×v̅-matrix (A) may be constructed by blocks, as shown below.

$$A := ( \begin{matrix}L & {R}_{0} & {R}_{1} & … & {R}_{j} & … & {R}_{p - 1} \\ {C}_{0} & {V}_{0} & {V}_{0} & … & {V}_{0} & … & {V}_{0} \\ {C}_{1} & {V}_{0} & {V}_{1} & … & {V}_{j} & … & {V}_{p - 1} \\ ⋮ & ⋮ & ⋮ & ⋱ & ⋮ & ⋱ & ⋮ \\ {C}_{i} & {V}_{0} & {V}_{i} & … & {V}_{ij} & … & {V}_{i ( p - 1 )} \\ ⋮ & ⋮ & ⋮ & ⋱ & ⋮ & ⋱ & ⋮ \\ {C}_{p - 1} & {V}_{0} & {V}_{p - 1} & … & {V}_{( p - 1 ) j} & … & {V}_{( p - 1 ) ( p - 1 )}\end{matrix} )$$

It is readily verified that matrix A above is the incidence matrix of a 2−(p²+p+1, p+1, 1) design, where the columns are identified with the points, and the rows with the members of [symbol] . For example, let p=11, then a storage system with n=12 and M=133 may use the foregoing combinatorial design to pick a co-derived data storage pattern set of t=133 perfectly balanced data storage patterns.

While combinatorial designs provide ideal balancing properties, embodiments employing the foregoing concepts are not limited to strictly combinatorial designs. Some practical embodiments may, for example, use patterns that are approximations of combinatorial designs. Approximations of combinatorial designs in this context are objects similar to designs, but where some of the rigid constraints of t̅-designs are relaxed, allowing for some tolerance and/or exceptions. For example, a set of blocks is a design only if each t̅-tuple of points is the subset of exactly λ̅ blocks. If a set of blocks does not strictly satisfy that constraint, but a relaxed version of it, then it is an approximate combinatorial design. For instance, if each t̅-tuple is the subset of at most λ̅′ and at least λ̅″ blocks, where λ̅′>λ̅″, then it can be considered an approximate combinatorial design. Similarly, if all but a negligible fraction of t̅-tuples are the subset of exactly λ̅ blocks, then it can also be considered an approximate design. When it comes to their use in co-derived pattern sets, approximate combinatorial designs can be as useful as exact combinatorial designs. For example, using a 2-design guarantees that if any pair of nodes fail, the same number of incident patterns is affected. In practice, this condition can be relaxed in various ways. Foregoing a set of patterns may be constructed such that any failure of a pair of nodes guarantees that at most c (for some constant c) patterns are affected, rather than requiring that exactly the same number of patterns is affected in each case. For a reasonably small c, this kind of set will behave similar to combinatorial designs in applications, while being far less restrictive. An alternative possible approximation is to construct the patterns in such a way that the vast majority of failing node pairs affects the same number of patterns, with very few exceptions. Using such approximate combinatorial designs has the advantage that it is far less rigid than exact combinatorial designs, and allows for more flexible choices of parameters.

Some of the algorithms above can be used to construct approximate combinatorial designs. There are, however, numerous other approaches that can be used to compute approximate combinatorial designs, and can hence be applied to find a suitable set of co-derived patterns, and/or to improve on an existing set of patterns. For example, optimization techniques such as simulated annealing or tabu search could be used as alternatives. The basic ideas of these approaches is to define a score that is minimized (or maximized) for an ideal solution and then execute the optimization method to find a good solution. For pattern sets, such a score could be the number of t-tuples of nodes that are incident with more than c patterns (where c is a constant).

It should be appreciated that the storage node environment within a storage system such as storage system 200 is typically dynamic in nature. For example, when storage nodes fail (e.g., temporarily and permanently), replacement storage nodes are added to the storage system etc. Static data storage patterns are not, however, well suited for meeting particular system performance goals. For example, when a replacement storage node is provided for a failed storage node, utilization of static data storage patterns may result in fragments for all data storage patterns incident with the failed storage node replaced by the replacement storage node being generated and written to the replacement storage node. This operation can result in unacceptable spikes in bandwidth utilization, blocking of access to that storage node, or other nearby nodes (e.g., those in the same rack). For example, when a storage node fails and is replaced, a typical repair process operates to fill the replacement node with new data, possibly creating a “hot spot” on the replacement storage node, and may take an appreciably long time to complete if the link to that storage node has a bandwidth limit. The source objects assigned to the data storage patterns incident with the failed storage node remain at increased risk of data loss until the replacement storage node designated for the failed storage node is added to the storage system and the repair for the respective source object completes. Accordingly, embodiments of co-derived pattern set management logic 253 utilize a relaxed patterns methodology at block 301 to construct co-derived data storage pattern sets that are adapted to the dynamically changing storage node environment.

Co-derived pattern set management logic 253, using a relaxed patterns methodology of embodiments, generates data storage patterns which distribute the repair load associated with failed storage nodes on the cluster of storage nodes in a balanced way while preserving the property that the storage loads are well distributed on the cluster of storage nodes. In implementing a relaxed patterns methodology by co-derived pattern set management logic 253 of embodiments, let s be a small integer (e.g., s=1) corresponding to the “slack” of a relaxed data storage pattern, wherein such slack represents an additional storage nodes included in a respective data storage pattern. Rather than a data storage pattern mapping to n storage nodes, a relaxed data storage pattern maps to n+s storage nodes. As an example, using the exemplary combinatorial design construction above, an embodiment of a relaxed pattern methodology may use n=11, s=1, and M=133, with a co-derived data storage set of 133 data storage patterns.

Embodiments of co-derived pattern set management logic 253 may provide a balanced construction for relaxed data storage patterns of size n+s (e.g., implementing one or more randomized constructions techniques and/or combinatorial designs techniques, as described above).

In one embodiment, each pattern has a dedicated set of slack nodes assigned. Let P(0), . . . , P(n+s−1) be an exemplary pattern in the system. By convention, suppose P(0), . . . , P(n−1) are the storage nodes in that pattern that contain the data fragments (called payload nodes henceforth), and P(n), P(n+s−1) are the slack nodes. The fragments with fragment ID i (0≦i<n) are then stored on storage node P(i). The following procedure is executed when a storage node incident with the pattern P fails:

```
j ← index such that P(j) is the newly failed node
if j < n then
      if there is a storage node among P(n), ..., P(n + s − 1) that is
      operational then
            i ← index of a random operational storage node amongst
            P(n), ..., P(n + s − 1)
            swap entries i and j in the pattern P
      end if
end if
```

Thus, if a payload node fails, it is logically exchanged with a slack node in the given pattern. The failed storage node becomes a slack node that will be operational as soon as it is replaced in the system, or when it otherwise resumes operation. It should be appreciated that this procedure ensures that after the swap in the above procedure, it is immediately possible to start producing repair data for the j-th fragment and placing it on the newly assigned node P₍ⱼ₎ according to embodiments herein. It should also be noted that since different patterns have in general different slack nodes, that repairs of storage node failures are distributed among a set of storage nodes, instead of concentrated on a single node.

When each relaxed data storage pattern contains the same amount of data, and the relaxed data storage patterns are perfectly balanced, any storage node will contain a factor at most (n+s)/n more data than an average storage node. More generally, if the relaxed data storage patterns are arranged in a t̅-design, the amount of data incident with any set of at most t̅ storage nodes is at most a factor of (n+s)/n larger than the expected amount of data incident with sets of nodes of the same size.

The choice of the parameter s involves a tradeoff. Smaller values of s ensure better balancing of the data, while larger values of s allow for better distribution of the repair process on the system. Embodiments may set s so that s·u≧M, where u is the number of patterns incident with any given node in order to achieve the goal of ensuring the repair write load of each node is equal. However, smaller values of s may be utilized according to embodiments to provide suitable balancing of the write load across the nodes while also achieving a suitable storage load balancing across nodes. If n is fairly small, and a good data and repair balancing is desirable, it is advantageous if u is large. This can be achieved, for example, by using patterns based on designs with moderately large values of λ̅. (Suitable such designs can be constructed recursively based on simpler designs with smaller λ̅.)

It should be appreciated that while the slack node approach provides some guarantees on balancing, embodiments may have additional elements to further improve balancing of both repair load and data in the system. For example, the system can periodically or continually scan for underutilized storage nodes. (Typically a replacement storage node for a previously failed storage node would be underutilized, due to all affected patterns associating it with a slack position.) Once an underutilized storage node is found, some of the incident patterns could then apply a swapping procedure very similar to the above to change their use in the pattern from slack to active. For example, a pseudorandom payload node in the pattern may be swapped with the underutilized slack node position in the pattern. The corresponding fragments would then be need to be moved from the old payload node to the swapped-in one. The system can gradually perform this operation on different patterns, so as to achieve a data rebalancing at a controlled rate that does not otherwise disrupt the cluster operation. It should be noted that this kind of process improves not only the data balancing, but also the repair load balancing in the system: storage node failures tend to align the slack nodes in different patterns, leading to some concentration of repair load in subsequent storage node failures. A redistribution of slack nodes as suggested here solves this issue.

Alternative embodiments use slack nodes somewhat differently. In utilization of relaxed data storage patterns, co-derived pattern set management logic 253 of embodiments may operate to randomly select n storage nodes of the n+s storage nodes in a relaxed data storage pattern to store a source object, and cause data storage management logic 252 to store fragments for that source object only on those n storage nodes. Thus, the slack nodes for two distinct objects on the same pattern may be different in this embodiment.

Repair or storage node replacement can be done in a way that distributes repair load on the cluster of storage nodes. For example, for each source object that needs to be repaired, a slack storage node can be used to place the replacement fragment, rather than the newly inserted storage node (it being appreciated that the source objects having a fragment erasure associated with a particular storage node will in general have different relaxed data storage patterns assigned thereto, and thus will likely utilize different slack storage nodes).

As in the previous embodiment, it is also desirable in this case to further improve the data and repair load balancing. A separate process can inspect the patterns and rearrange the data placement for the individual objects such that each storage node in the pattern stores approximately the same amount of data for objects of the pattern. This ensures better overall node balancing as well as equal repair load balancing.

This alternative embodiment provides the same balancing guarantee as the previous embodiment. It spreads the repair load of each affected pattern equally among the storage nodes in the pattern, and can thus spread to repair write load to the whole cluster if (n+s−1)·s·u≧M.

Having created a co-derived data storage pattern set at block 301, the illustrated embodiment of flow 300 proceeds to block 302 wherein the data storage patterns of the co-derived data storage pattern set are provided for use in storing source objects to storage system 200. For example, co-derived pattern set management logic 253 may store the data storage patterns of a co-derived data storage pattern set to co-derived data storage patterns database 254, such as for later access by co-derived pattern set management logic 253 and/or data storage management 252. Rather than generating one or more co-derived pattern sets and storing such sets for later use in data storage operations, embodiments herein may operate to create a co-derived data storage pattern set during data storage operations (e.g., “on the fly” or in “real-time”). Such embodiments may operate to store parameters and/or other information (e.g., within co-derived data storage patterns database 254) from which appropriate co-derived data storage pattern sets may be created in accordance with the concepts herein. Irrespective of the particular timing of the creation of co-derived data storage pattern sets, embodiments nevertheless provides one or more such co-derived data storage pattern sets for use in storing source objects. For example, in operation of storage system 200, data storage management 252 and co-derived pattern set management logic 253 may cooperate to assign data storage patterns of a co-derived data storage pattern set to source objects for the storing of fragments on the storage nodes. Additionally or alternatively, co-derived pattern set management logic 253 may operate to update and/or modify a co-derived data storage pattern set, and/or data storage patterns thereof, stored in co-derived data storage patterns database 254.

As another example of co-derived data storage pattern sets provided in accordance with concepts herein, embodiments utilizing a using a large erasure code, for example, may provide co-derived data storage pattern sets comprising parallel patterns, where each pattern intersects exactly one storage node within a same physical equipment rack. For example, in accordance with embodiments, if there are 40 storage nodes per equipment rack, there are 40 patterns, wherein each pattern involves one storage node from each rack of the design. In this example, there might be 1000 racks, as an example, and thus each co-derived parallel pattern might comprise n=1000 storage nodes. It should be appreciated that the foregoing parallel patterns are “disjoint” (i.e., each storage node is incident with one pattern).

The repair process for each pattern may be operated sequentially (only one pattern is being repaired at a time) according to embodiments (e.g., the repair may be run for one pattern for one hour each forty hours, so that at each point in time one pattern is repairing). Such operation may be provided to save (peak and average) power in a cold storage system (e.g., at any point in time only one of the storage nodes within the equipment rack needs to be powered up, and then all network bandwidth at that point in time is for repair of that one pattern). Thus, the power needed for the equipment rack (average and peak) is substantially decreased (e.g., by a factor of 40 in the foregoing example).

Embodiments of a storage system implementing co-derived data storage pattern sets herein may implement additional robust functionality, such as one or more data storage, data management, data redundancy, and/or data resiliency verification techniques. Examples of such robust storage system functionality as may be implemented in combination with co-derived data storage pattern sets are described in United States patent applications serial number [Docket Number 153952U1] entitled “SYSTEMS AND METHODS FOR VERIFICATION OF CODE RESILIENCY FOR DATA STORAGE,” serial number [Docket Number 153952U2] entitled “SYSTEMS AND METHODS FOR VERIFICATION OF CODE RESILIENCY FOR DATA STORAGE,” serial number [Docket Number 153986] entitled “SYSTEMS AND METHODS FOR PRE-GENERATION AND PRE-STORAGE OF REPAIR FRAGMENTS IN STORAGE SYSTEMS,” serial number [Docket Number 154063U1] entitled “SYSTEMS AND METHODS FOR DATA ORGANIZATION IN STORAGE SYSTEMS USING LARGE ERASURE CODES,” serial number [Docket Number 154063U2] entitled “SYSTEMS AND METHODS FOR DATA ORGANIZATION IN STORAGE SYSTEMS USING LARGE ERASURE CODES,” serial number [Docket Number 153953U1] entitled “SYSTEMS AND METHODS FOR REPAIR RATE CONTROL FOR LARGE ERASURE CODED DATA STORAGE,” and serial number [Docket Number 153953U2] entitled “SYSTEMS AND METHODS FOR REPAIR RATE CONTROL FOR LARGE ERASURE CODED DATA STORAGE,” each filed concurrently herewith, the disclosures of which are hereby incorporated herein by reference.

For example, distributed storage control logic 250 may, in addition to including co-derived pattern set management logic 253, include data integrity forward checking logic operable to analyze combinations of the remaining fragments for one or more source objects (e.g., source objects at the head of the repair queue) stored by the storage nodes for each of the data storage patterns utilized by the storage system, as described in the above patent applications entitled “SYSTEMS AND METHODS FOR VERIFICATION OF CODE RESILIENCY FOR DATA STORAGE”. Accordingly, where a plurality of data storage patterns are utilized, such as by an embodiment implementing the aforementioned ESI patterns, each ESI pattern can be verified for code resiliency in operation according to embodiments of a verification of code resiliency technique. It should be appreciated that implementation of such ESI pattern embodiments greatly ameliorates the concern that the underlying erasure code, such as RAPTORQ, is not a MDS code, and greatly reduces the risk of having to perform emergency repair at a very high overall peak repair rate. Accordingly, such techniques for specifying ESI patterns are combined with techniques for verification of code resiliency according to embodiments herein to provide highly resilient storage of source data with data viability monitoring.

It should be appreciated that the foregoing implementation of techniques for specifying data storage patterns combined with techniques for verification of code resiliency increases the verification of code resiliency computation. However, during normal operation, when the verification of code resiliency functionality is passing for all ESI patterns, typically the amount of repair for each of the ESI patterns is close to equal (e.g., each repair process uses approximately 1% of the repair bandwidth being used at a steady rate), since generally an equal amount of source object data is assigned to each ESI pattern. It should be appreciated that it is unlikely that the verification of code resiliency will fail for more than one ESI pattern at a time when an erasure code that is not inherently MDS such as RAPTORQ is used, since generally decoding is possible with high probability as long as fragments associated with k or slightly more than k ESIs are available and thus it is unlikely that more than one ESI pattern at a time will fail the verification of code resiliency test if there are not a large number of ESI patterns. Thus if one ESI pattern does fail and needs emergency repair processing, the emergency repair process for that ESI pattern can be sped up by a significant factor (e.g., by a factor of 100), possibly while the repair processes for the remaining ESI patterns is slowed down (e.g., to zero) during the emergency repair. As an alternative, the repair processes for the remaining ESI patterns may continue at their usual rate while the emergency repair is sped up, for example by a factor of 100, and thus during the time the emergency repair is occurring the global repair bandwidth usage is increased by a factor of at most two. Thus, the global peak repair bandwidth used by the repair processes for all of the ESI patterns can be maintained at a smooth and steady level even in the rare event that emergency repair is triggered due to failure of the verification of code resiliency for one or more ESI patterns. This alleviates the need for the underlying erasure code, such as RAPTORQ, to provide extremely high reliable decoding (MDS-like).

As an example of the above described use of ESI patterns with a verification of code resiliency technique according to embodiments, suppose the erasure code has failure probability of at most 10⁻⁹ for decoding from a random set of 2200 ESIs (i.e., each object of a set of objects associated with a given ESI pattern has fragments stored on each of 2200 available storage nodes). The verification of code resiliency for a particular ESI pattern may fail with probability 10⁻⁴ (e.g., check decoding with 10⁵ different sets of ESIs to verify resiliency against 5 future storage node failures). Thus, on average an ESI pattern may fail the verification of code resiliency test with probability at most 10⁻⁴. The chance that more than 5 out of the 100 ESI patterns fail at the same time is thus at most (100 choose 5)*10^{(-4*5)}≦10⁻¹². If there are 5 failing ESI patterns at the same time, then the repair process for each of these 5 ESI patterns can use up to 20 times the normal repair bandwidth for emergency repair, while the repair processes for the remaining 95 ESI patterns remain temporarily quiescent until the emergency subsides, and the global peak repair bandwidth will remain the same when emergency repair is occurring as when there is no emergency repair. Alternatively, if there are 5 failing patterns at the same time, then the repair process for each of these 5 ESI patterns can use up to 20 times the normal repair bandwidth for emergency repair, while the repair processes for the remaining 95 ESI patterns proceeds with normal repair, and the global peak repair bandwidth when emergency repair is occurring will be at most twice as when there is no emergency repair.

Embodiments of storage system 200 implement a fragment pre-storage technique, as described in the above patent application entitled “SYSTEMS AND METHODS FOR PRE-GENERATION AND PRE-STORAGE OF REPAIR FRAGMENTS IN STORAGE SYSTEMS,” to generate a number of fragments for a particular source object that is greater than the number of storage nodes used to store the fragments (e.g., greater than the number of storage nodes in the storage system for certain large erasure codes). The fragments generated that do not have a corresponding assigned storage node for their storage at the time of their generation are thus “pre-generated” and “pre-stored” (e.g., in unused space then being utilized as “virtual” storage) for later moving to an assigned storage node (e.g., a storage node subsequently added to the storage system). In another variant utilizing ESI patterns herein in combination with such a fragment pre-storage technique, for each storage node I there is an ESI pattern PESIpat(I) assigned as the permanent ESIs to current available storage nodes to be utilized for source objects assigned to storage node I, a set of future ESIs FESIpat(I) to be utilized for source objects assigned to storage node I, and a subset of the source objects O(I) assigned to storage node I, wherein approximately an equal amount of source object data is assigned to each storage node and the objects O(I) assigned to storage node I have fragments stored among the current available storage nodes according to the ESI pattern PESIpat(I). The ESI sets PESIpat(I) and FESIpat(I) may be determined in a coordinated way for different storage nodes I, as described above, and generally these sets are disjoint. Each storage node I may be responsible for operating the repair process and pre-generating repair fragments associated with the set of future ESIs FESIpat(I) and source objects O(I) assigned to storage node I and storing the repair fragments locally at the storage node I in virtual storage. When a new storage node J is added to the storage system, each storage node I may be responsible for assigning an ESI X from FESIpat(I) as its permanent ESI for storage node J, thus extending PESIpat(I) to map ESI X to storage node J. Additionally, each storage node I may also be responsible for moving the repair fragments associated with ESI X from virtual storage on storage node I to permanent storage on the new storage node J. Each storage node I may further be responsible for executing the verification resiliency test for PESIpat(I) (e.g., when a storage node fails and thus PESIpat(I) loses the ESI assigned to the failed storage node, the verification resiliency test can be executed on the reduced PESIpat(I)). If at any point in time the verification resiliency test fails at a storage node I, the storage node I may redistribute repair responsibility for the source objects O(I) assigned to the storage node to the other storage nodes in the storage system (e.g., with an indication that the objects so redistributed are in need of emergency repair). The other storage nodes that receive the redistributed responsibility for repair of the source objects that need repair schedule the repair of source objects O(I) received from storage node I (e.g., schedule repair as soon as possible, potentially using more than the usual amount of repair bandwidth during the emergency repair). Once the repair finishes, the responsibility for repair of the redistributed source objects may be returned to storage node I. In accordance with an alternative embodiment for the foregoing, the repair responsibility for the source objects remains with the storage nodes to which they were redistributed, and the ESI pattern used for storage of the source object is changed to that of the storage node to which they are redistributed (e.g., during the redistributed repair, the ESI pattern for the source object may be changed to the ESI pattern of the storage node performing the repair).

In still another variant utilizing ESI patterns herein in combination with such a fragment pre-storage technique, in some cases a collection of source objects may have the nesting property S(0) subset S(1) subset S(2) subset . . . S(Z), where each set S(I) is a set of ESIs, and where S(0) is the set of ESIs for available fragments for the objects with the least number of available fragments, S(1) is the set of ESIs for available fragments for objects with the second least number of fragments, etc. In this case, the verification resiliency test may be run on the set S(0), and if the test passes then no further testing is needed since the test is also guaranteed to pass on S(1), S(2), . . . , S(Z). However, if the verification resilience test fails on S(0), then the test can be run on S(1), and if the test fails on S(1) then the test can be run on S(2), until the smallest index I is determined wherein the test fails on S(I) but passes on S(I+1). It should be appreciated that a sequential search, a binary search or other methods may be used to determine the smallest index I according to embodiments. Irrespective of the technique used to determine I, the set of source objects that may require emergency repair may be identified as those associated with the sets S(0), . . . , S(1), but potentially excluding source objects associated with S(I+1), . . . , S(Z). An advantage of this extension of the embodiments is that there may be substantially less source objects needing emergency repair (i.e., those associated with S(0), . . . , S(I), as opposed to all objects), which can substantially reduce the amount and duration of emergency repair needed. For example, it may be typical that the verification resiliency test passes for S(1) when the test fails on S(0), and it may also be typical that there is an equal amount of source object data associated with each of S(0), S(1), . . . , S(Z). Thus, the fraction of source object data needing emergency repair in this example may be a 1/Z fraction of the source object data within the collection of source objects, wherein for example Z may equal 800 for a k=2000, r=1000, and n=3000 liquid storage system, i.e., Z is at most r but may be a substantial fraction of r.

For an example of a combination of aspects of some of the foregoing techniques, consider a liquid storage system with k=2000, r=1000, and n=3000. For the variant described above with respect to a distributed ESI pattern embodiment, there are 3000 ESI patterns, one for each of the 3000 storage nodes. In this example, each storage node I is assigned source objects O(I) that are in aggregate approximately 1/3000 the size of all the source object data, and each storage node I may execute a repair process for O(I) using its assigned ESI pattern ESIpat(I) to determine how to store fragments on the storage nodes. Additionally each storage node I may execute verification resilience tests for ESIpat(I). Where for each storage node I the collection of source objects O(I) assigned to storage node I have the nesting property, and S(0,I), S(1,I), . . . , S(Z,I) are the corresponding nested sets of ESIs, if the verification resiliency test fails at some point in time, it may fail for one (or a handful) of storage nodes, and for one (or a handful) of the corresponding nested sets of ESIs. If, at some point in time, the verification test fails for exactly one storage node I and for exactly one set of ESIs S(0,1), then the fraction of source objects for which this triggers emergency repair is approximately a 1/3,000* 1/800 fraction (assuming Z=800 and source objects are equally distributed amongst S(0,I), S(1,I), . . . , S(Z,I)), or a 1/2,400,000 fraction of the source object data overall. If, for example, there are 100 terabytes of source object data stored at each storage node, so that overall there is 200,000 terabytes of source object data stored in the storage system (100 TB*k), then the size of the source objects which need emergency repair is less than 100 gigabytes. When this emergency repair is redistributed amongst the 3000 available storage nodes, each storage node performs emergency repair on less than 33 megabytes of source object data.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for providing a set of data storage patterns for storing a plurality of source objects as a plurality of fragments on a plurality of storage nodes of a distributed storage system, the method comprising:
constructing, by processor-based logic, a co-derived data storage pattern set having a plurality of data storage patterns, wherein each data storage pattern of the plurality of data storage patterns designate a subset of storage nodes on which fragments of a source object are to be stored, and wherein the plurality of data storage patterns are derived using at least one collective set-based construction methodology; and
providing the co-derived data storage pattern set for assignment of one of the data storage patterns of the plurality of data storage patterns to each source object of the plurality of source objects.

2. The method of claim 1, further comprising:
storing the co-derived data storage pattern set for assignment of data storage patterns of the data storage patterns to each source object of the plurality of source objects.

3. The method of claim 1, wherein the constructing and providing the co-derived data storage pattern set is performed in real-time during storage of source objects of the plurality of source objects to the distributed storage system.

4. The method of claim 1, wherein the plurality of data storage patterns of the co-derived data storage pattern set are mutually cooperative to meet one or more performance goals of the distributed storage system.

5. The method of claim 1, wherein the one or more performance goals comprise at least one distributed storage system performance goal selected from the group consisting of storage node load balancing, balancing of source object data assigned to storage node patterns, data reliability, reduced storage node spare capacity, repair bandwidth efficiency, maintaining performance objectives as availability of storage nodes changes, and accommodating storage system configuration changes.

6. The method of claim 1, wherein the at least one collective set-based construction methodology comprises a randomized construction.

7. The method of claim 6, wherein the data storage patterns of the co-derived data storage pattern set constructed using the randomized construction collectively show equal sharing of the data storage patterns per storage node.

8. The method of claim 6, wherein the randomized construction comprises:
generating the plurality of data storage patterns so that each storage node of the plurality of storage nodes is designated by a same number of data storage patterns.

9. The method of claim 6, wherein the randomized construction ensures that groupings of the storage nodes have a same number of the data storage patterns of the plurality of data storage patterns incident thereon.

10. The method of claim 9, wherein the groupings of the storage nodes comprise a grouping selected from the group consisting of pairs, triples, and quadruples.

11. The method of claim 1, wherein the at least one collective set-based construction methodology comprises a combinatorial design.

12. The method of claim 1, wherein the at least one collective set-based construction methodology comprises an approximation of a combinatorial design, wherein the approximation of a combinatorial design does not strictly satisfy at least one constraint of a combinatorial design but is otherwise corresponds to a combinatorial design.

13. The method of claim 12, wherein the approximation of a combinatorial design comprises a design structure that satisfies constraints for less than all t-uplets.

14. The method of claim 11, wherein the data storage patterns of the co-derived data storage pattern set constructed using the combinatorial design minimize storage node commonality between the data storage patterns in the set of data storage patterns.

15. The method of claim 11, wherein the combinatorial design comprises a projective geometries design.

16. The method of claim 11, wherein the combinatorial design comprises a Steiner system design.

17. The method of claim 1, wherein the at least one collective set-based construction methodology comprises a relaxed patterns construction.

18. The method of claim 17, wherein the data storage patterns of the co-derived data storage pattern set constructed using the relaxed patterns construction are adaptive to a dynamically changing storage node environment of the distributed storage system.

19. The method of claim 17, wherein the subset of storage nodes designated in each data storage set of the plurality of data storage sets includes at least one slack storage node, wherein fragments of a source object which are stored to the distributed storage system are stored to less than all the storage nodes designated in an assigned one of the data storage patterns.

20. The method of claim 19, wherein a number of storage nodes equal to a number of the at least one slack storage node is initially unused for storing a fragment of a source object assigned to a particular data storage pattern of the plurality of data storage patterns.

21. The method of claim 20, wherein a storage node of the at least one slack storage node is used for storing a repair fragment of the source object assigned to the particular data storage pattern when another storage node of the particular data pattern fails.

22. The method of claim 1, wherein the processor-based logic constructing the co-derived data storage pattern set comprises co-derived pattern set management logic, and wherein data storage patterns of the plurality of data storage patterns are assigned to the source objects stored in the distributed storage system by data storage management logic of the distributed storage system.

23. An apparatus for providing a set of data storage patterns for storing a plurality of source objects as a plurality of fragments on a plurality of storage nodes of a distributed storage system, the apparatus comprising:
one or more data processors; and
one or more non-transitory computer-readable storage media containing program code configured to cause the one or more data processors to perform operations including:
constructing a co-derived data storage pattern set having a plurality of data storage patterns, wherein each data storage pattern of the plurality of data storage patterns designate a subset of storage nodes on which fragments of a source object are to be stored, and wherein the plurality of data storage patterns are derived using at least one collective set-based construction methodology; and
providing the co-derived data storage pattern set for assignment of data storage patterns of the data storage patterns to each source object of the plurality of source objects.

24. The apparatus of claim 23, wherein the program code is further configured to cause the one or more data processors to perform operations including:
storing the co-derived data storage pattern set for assignment of data storage patterns of the data storage patterns to each source object of the plurality of source objects.

25. The apparatus of claim 23, wherein the constructing and providing the co-derived data storage pattern set is performed in real-time during storage of source objects of the plurality of source objects to the distributed storage system.

26. The apparatus of claim 23, wherein the plurality of data storage patterns of the co-derived data storage pattern set are mutually cooperative to meet one or more performance goals of the distributed storage system.

27. The apparatus of claim 26, wherein the one or more performance goals comprise at least one distributed storage system performance goal selected from the group consisting of storage node load balancing, balancing of source object data assigned to storage node patterns, data reliability, reduced storage node spare capacity, repair bandwidth efficiency, maintaining performance objectives as availability of storage nodes changes, and accommodating storage system configuration changes.

28. The apparatus of claim 23, wherein the at least one collective set-based construction methodology comprises a randomized construction.

29. The apparatus of claim 28, wherein the data storage patterns of the co-derived data storage pattern set constructed using the randomized construction collectively show equal sharing of the data storage patterns per storage node.

30. The apparatus of claim 28, wherein the randomized construction comprises:
generating the plurality of data storage patterns so that each storage node of the plurality of storage nodes is designated by a same number of data storage patterns.

31. The apparatus of claim 28, wherein the randomized construction ensures that groupings of the storage nodes have a same number of the data storage patterns of the plurality of data storage patterns incident thereon.

32. The apparatus of claim 31, wherein the groupings of the storage nodes comprise a grouping selected from the group consisting of pairs, triples, and quadruples.

33. The apparatus of claim 23, wherein the at least one collective set-based construction methodology comprises a combinatorial design.

34. The apparatus of claim 23, wherein the at least one collective set-based construction methodology comprises an approximation of a combinatorial design, wherein the approximation of a combinatorial design does not strictly satisfy at least one constraint of a combinatorial design but is otherwise corresponds to a combinatorial design.

35. The apparatus of claim 34, wherein the approximation of a combinatorial design comprises a design structure that satisfies constraints for less than all t-uplets.

36. The apparatus of claim 33, wherein the data storage patterns of the co-derived data storage pattern set constructed using the combinatorial design minimize storage node commonality between the data storage patterns in the set of data storage patterns.

37. The apparatus of claim 33, wherein the combinatorial design comprises a projective geometries design.

38. The apparatus of claim 33, wherein the combinatorial design comprises a Steiner system design.

39. The apparatus of claim 23 wherein the at least one collective set-based construction methodology comprises a relaxed patterns construction.

40. The apparatus of claim 39, wherein the data storage patterns of the co-derived data storage pattern set constructed using the relaxed patterns construction are adaptive to a dynamically changing storage node environment of the distributed storage system.

41. The apparatus of claim 39, wherein the subset of storage nodes designated in each data storage set of the plurality of data storage sets includes at least one slack storage node, wherein fragments of a source object which are stored to the distributed storage system are stored to less than all the storage nodes designated in an assigned one of the data storage patterns.

42. The apparatus of claim 41, wherein a number of storage nodes equal to a number of the at least one slack storage node is initially unused for storing a fragment of a source object assigned to a particular data storage pattern of the plurality of data storage patterns.

43. The apparatus of claim 42, wherein a storage node of the at least one slack storage node is used for storing a repair fragment of the source object assigned to the particular data storage pattern when another storage node of the particular data pattern fails.

44. An apparatus for providing a set of data storage patterns for storing a plurality of source objects as a plurality of fragments on a plurality of storage nodes of a distributed storage system, the apparatus comprising:
means for constructing a co-derived data storage pattern set having a plurality of data storage patterns, wherein each data storage pattern of the plurality of data storage patterns designate a subset of storage nodes on which fragments of a source object are to be stored, and wherein the plurality of data storage patterns are derived using at least one collective set-based construction methodology; and
means for providing the co-derived data storage pattern set for assignment of data storage patterns of the data storage patterns to each source object of the plurality of source objects.

45. The apparatus of claim 44, further comprising:
means for storing the co-derived data storage pattern set for assignment of data storage patterns of the data storage patterns to each source object of the plurality of source objects.

46. The apparatus of claim 44, wherein the at least one collective set-based construction methodology comprises a randomized construction.

47. The apparatus of claim 46, wherein the data storage patterns of the co-derived data storage pattern set constructed using the randomized construction collectively show equal sharing of the data storage patterns per storage node.

48. The apparatus of claim 46, wherein the randomized construction comprises:
means for generating the plurality of data storage patterns so that each storage node of the plurality of storage nodes is designated by a same number of data storage patterns.

49. The apparatus of claim 46, wherein the randomized construction ensures that groupings of the storage nodes have a same number of the data storage patterns of the plurality of data storage patterns incident thereon.

50. The apparatus of claim 49, wherein the groupings of the storage nodes comprise a grouping selected from the group consisting of pairs, triples, and quadruples.

51. The apparatus of claim 44, wherein the at least one collective set-based construction methodology comprises a combinatorial design.

52. The apparatus of claim 44, wherein the at least one collective set-based construction methodology comprises an approximation of a combinatorial design, wherein the approximation of a combinatorial design does not strictly satisfy at least one constraint of a combinatorial design but is otherwise corresponds to a combinatorial design.

53. The apparatus of claim 52, wherein the approximation of a combinatorial design comprises a design structure that satisfies constraints for less than all t-uplets.

54. The apparatus of claim 51, wherein the data storage patterns of the co-derived data storage pattern set constructed using the combinatorial design minimize storage node commonality between the data storage patterns in the set of data storage patterns.

55. The apparatus of claim 51, wherein the combinatorial design comprises a projective geometries design.

56. The apparatus of claim 51, wherein the combinatorial design comprises a Steiner system design.

57. The apparatus of claim 44, wherein the at least one collective set-based construction methodology comprises a relaxed patterns construction.

58. The apparatus of claim 57, wherein the data storage patterns of the co-derived data storage pattern set constructed using the relaxed patterns construction are adaptive to a dynamically changing storage node environment of the distributed storage system.

59. The apparatus of claim 57, wherein the subset of storage nodes designated in each data storage set of the plurality of data storage sets includes at least one slack storage node, wherein fragments of a source object which are stored to the distributed storage system are stored to less than all the storage nodes designated in an assigned one of the data storage patterns.

60. The apparatus of claim 59, wherein a number of storage nodes equal to a number of the at least one slack storage node is initially unused for storing a fragment of a source object assigned to a particular data storage pattern of the plurality of data storage patterns.

61. The apparatus of claim 60, wherein a storage node of the at least one slack storage node is used for storing a repair fragment of the source object assigned to the particular data storage pattern when another storage node of the particular data pattern fails.

62. A non-transitory computer-readable medium comprising codes for providing a set of data storage patterns for storing a plurality of source objects as a plurality of fragments on a plurality of storage nodes of a distributed storage system, the codes causing a computer to:
construct a co-derived data storage pattern set having a plurality of data storage patterns, wherein each data storage pattern of the plurality of data storage patterns designate a subset of storage nodes on which fragments of a source object are to be stored, and wherein the plurality of data storage patterns are derived using at least one collective set-based construction methodology; and
provide the co-derived data storage pattern set for assignment of data storage patterns of the data storage patterns to each source object of the plurality of source objects.

63. The non-transitory computer-readable medium of claim 62, wherein the codes further cause the computer to:
store the co-derived data storage pattern set for assignment of data storage patterns of the data storage patterns to each source object of the plurality of source objects.

64. The non-transitory computer-readable medium of claim 62, wherein the at least one collective set-based construction methodology comprises a randomized construction.

65. The non-transitory computer-readable medium of claim 64, wherein the data storage patterns of the co-derived data storage pattern set constructed using the randomized construction collectively show equal sharing of the data storage patterns per storage node.

66. The non-transitory computer-readable medium of claim 64, wherein the plurality of data storage patterns constructed using the randomized construction provide for each storage node of the plurality of storage nodes being designated by a same number of data storage patterns.

67. The non-transitory computer-readable medium of claim 64, wherein the randomized construction ensures that groupings of the storage nodes have a same number of the data storage patterns of the plurality of data storage patterns incident thereon.

68. The non-transitory computer-readable medium of claim 67, wherein the groupings of the storage nodes comprise a grouping selected from the group consisting of pairs, triples, and quadruples.

69. The non-transitory computer-readable medium of claim 62, wherein the at least one collective set-based construction methodology comprises a combinatorial design.

70. The non-transitory computer-readable medium of claim 62, wherein the at least one collective set-based construction methodology comprises an approximation of a combinatorial design, wherein the approximation of a combinatorial design does not strictly satisfy at least one constraint of a combinatorial design but is otherwise corresponds to a combinatorial design.

71. The non-transitory computer-readable medium of claim 70, wherein the approximation of a combinatorial design comprises a design structure that satisfies constraints for less than all t-uplets.

72. The non-transitory computer-readable medium of claim 69, wherein the data storage patterns of the co-derived data storage pattern set constructed using the combinatorial design minimize storage node commonality between the data storage patterns in the set of data storage patterns.

73. The non-transitory computer-readable medium of claim 69, wherein the combinatorial design comprises a projective geometries design.

74. The non-transitory computer-readable medium of claim 69, wherein the combinatorial design comprises a Steiner system design.

75. The non-transitory computer-readable medium of claim 62, wherein the at least one collective set-based construction methodology comprises a relaxed patterns construction.

76. The non-transitory computer-readable medium of claim 75, wherein the data storage patterns of the co-derived data storage pattern set constructed using the relaxed patterns construction are adaptive to a dynamically changing storage node environment of the distributed storage system.

77. The non-transitory computer-readable medium of claim 75, wherein the subset of storage nodes designated in each data storage set of the plurality of data storage sets includes at least one slack storage node, wherein fragments of a source object which are stored to the distributed storage system are stored to less than all the storage nodes designated in an assigned one of the data storage patterns.

78. The non-transitory computer-readable medium of claim 77, wherein a number of storage nodes equal to a number of the at least one slack storage node is initially unused for storing a fragment of a source object assigned to a particular data storage pattern of the plurality of data storage patterns.

79. The non-transitory computer-readable medium of claim 78, wherein a storage node of the at least one slack storage node is used for storing a repair fragment of the source object assigned to the particular data storage pattern when another storage node of the particular data pattern fails.
